(19) United States
(12) Patent Application Publication
(10) Pub. No.: US 2004/0157140 A1
(43) Pub. Date: Aug. 12, 2004

(54) Photosensitive coloring composition, color filter using the composition and method of producing the same

(76) Inventors: Hirotoshi Kamata, Kanagawa (JP); Mina Onishi, Kanagawa (JP); Tsuyoshi Katoh, Chiba (JP); Yoshio Miyajima, Kanagawa (JP); Katsumi Murofushi, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/477,357

(22) PCT Filed: May 14, 2002
(86) PCT No.: PCT/JP02/04645

(30) Foreign Application Priority Data
May 15, 2001 (JP) 2001-144200
Jun. 15, 2001 (JP) 2001-182162
Aug. 2, 2001 (JP) 2001-235902

(51) Int. Cl. G02B 5/20

(52) U.S. Cl. 430/7; 430/270.1; 430/281.1

(57) ABSTRACT

A photosensitive coloring composition for color filters using coloring compositons containd (A) a binder resin having an amido group and a carboxyl group and (B) a coloring material has excellent photosensitivity and has improved dispersibility upon producing in particular a coloring composition containing a black pigment such as a carbon black. Use of (A) an epoxy(meth)acrylate resin can further improve the photosensitivity and from a black matrix having sufficient film strenght and low reflectivity. Furhter, use of a modified carbon black treated with a compound having a isocyanate group and an ethylenically unsaturaged bond in a molecule as the coloring material can give rise to a photosensitive resin composition excellent in optically opaque property, photosensitivity and dispersion stability.

### CROSS-REFERENCE TO RELATED APPLICATIONS

The present application is an application filed pursuant to 35 U.S.C. Section 111 (a) with a claim to priorities to Provisional Application Serial No. 60/292,527 filed May 23, 2001, Provisional Application Serial No. 60/301,235 filed Jun. 28, 2001, and Provisional Application Serial No. 60/311,075 filed Aug. 10, 2001 pursuant to 35 U.S.C. Section 119(e) in accordance with 35 U.S.C., Section 111(b).

### TECHNICAL FIELD

The present invention relates to a photosensitive coloring composition for color filters for use in the production of optical color filters used for color television sets, liquid crystal display devices, solid imaging devices, cameras and the like, and to a coloring composition utilized therein. More particularly, the present invention relates to a photosensitive coloring composition for color filters suitable for the production of black matrices, which has high optically opaque property and at the same time has high sensitivity and low reflectivity.

### BACKGROUND ART

Color filters generally include a transparent substrate such as a glass or plastic sheet having formed on a surface thereof a matrix having a black color (black matrix) and then color patterns of three or more different colors, such as red (R), green (G), blue (B), in the form of stripes or mosaics superposed in the order cited. The size of pattern may vary depending on the application of color filter and according to each color but is usually on the order of from 5 to 700 μm. The precision of position of superposition is from several μm to several tens μm and the color filters are produced by micromachining technology with high dimensional precision.

Typical production methods for producing color filters include a dyeing method, a printing method, a pigment dispersion method, an electrode position method and the like. Among these methods, in particular the pigment dispersion in which a photosensitive composition containing a colorant is coated on a transparent substrate and then imagewise exposure, development and optionally curing are repeated to form a color filter image has been widely adopted because it can give products with high precision in terms of the position of pixels of color filter and of film thickness as well as excellent durability such as light resistance or heat resistance and less defects such as pinholes.

Generally black matrix is arranged in the form of grids, stripes or mosaics between the color patterns of R, G and B, and functions to increase contrast by inhibition of color mixing between the colors and to prevent malfunction of TFT due to leakage of light. For this reason, black matrices have to have high optically opaque property. Heretofore, black matrices have been commonly formed as films of a metal such as chromium oxide. This technique involving vapor deposition of a metal such as chromium oxide on a transparent substrate and etching the chromium oxide layer through the process of photolithography gives rise to high optically opaque property with high precision despite small thickness. On the other hand, it is a technique that requires a long production process and exhibits low productivity and also involves the problems of high cost, environmental pollution by waste liquors produced in etching treatment and the like.

Accordingly, intensive studies have been made in pursuit of a technique for forming a pollution-free black matrix (resin black matrix) from a photosensitive resin having dispersed therein a light absorption pigment or dye at low costs. However, since resin black matrices have various problems as described hereinbelow, none of them has been put into practical use yet.

To realize the optically opaque property (optical density) equivalent to that of the black matrix made of a film of a metal such as chromium oxide in a resin black matrix, it is necessary that the light absorption pigment or dye be contained in increased amounts or the thickness of the black matrix be increased.

In the method of increasing the film thickness, the evenness of color pixels of RGB formed on the black matrix is deteriorated due to the influence of unevenness of the black matrix. This results in uneven liquid crystal cell gap or disturbance in the orientation of liquid crystal, thereby causing a decrease in the display performance. Also, the problem of disconnection of a transparent electrode ITO layer provided on the color filter arises.

Further, the method of increasing the content of light absorption pigment or dye has the problems of deteriorated sensitivity, developability, resolution, adhesion and the like of photosensitive resin (black resist) so that not only the productivity is reduced but also precision and reliability required for color filters cannot be obtained. That is, a failure in realizing a photosensitive material that exhibits satisfactory sensitivity, developability, resolution and adhesion while being a thin film and having high optically opaque property prevents the resin black matrix from being put into practical use.

Conventionally, various techniques have been known for improving the performances including sensitivity, developability, resolution, adhesion and the like of photosensitive resin having certain light transmittance such as general photosensitive resins or photosensitive coloring compositions for color filters. For example, JP 1-152449 A, JP 1-254918 A, JP 2-153353 A, and JP 2-804 A disclose compositions composed of a binder resin, a polyfunctional acrylic monomer, and a triazine compound as an initiator as coloring compositions for color filters having pigments dispersed therein. Also, JP 6-75372 A and JP 6-75373 A disclose similar compositions which contain biimidazole as an initiator. However, in the case of the compositions disclosed in these publications, they are susceptible to inhibition of polymerization due to oxygen when they are exposed to light in air so that in order to obtain practically usable sensitivity, an oxygen blocking layer such as one formed of polyvinyl alcohol must be provided, which makes the production process complicated.

JP 4-340965 A proposes as a technique for mitigating the above-mentioned defect, i.e., polymerization inhibition due to oxygen, a photosensitive coloring composition containing a large amount of a polymerizable compound. However, such a composition has a considerably large content of polymerizable compound which is as large as 60% or more, which poses a limitation on the blending amount of the coloring component so that it is difficult to apply this technique to compositions where a large amount of colorant is required, such as in the case of a resin black matrix. Further, JP 6-27662 A and JP 3-36212 B propose methods for reducing polymerization inhibition by adding amino acid derivatives or phosphorus compounds. However, these methods exhibit insufficient improving effects or have problems of odor or instability so that they are not practically usable.

Techniques for improving the resolution and developability include, for example, blending of binder resins having double bonds in the side chains as exemplified in JP 5-19467 A, binder resins having a controlled molecular weight distribution as exemplified in JP 6-175362 A, and poly thiol as exemplified in JP 5-281734 A, as well as addition of organic carboxylic acids as exemplified in JP 4-369653 A. All of them are compositions intended to form colored pixel portions of RGB in color filters. The sensitivity, resolution and developability when a light absorption pigment such as carbon black is blended are unclear.

On the other hand, as a method of increasing the photosensitivity of resin black matrix having high optically opaque property, there has been recently developed a photopolymerizable composition using novolak epoxyacrylate having a carboxyl group, which is a reactive binder, as the binder resin and a biimidazole compound and a poly thiol as photoinitiators, as disclosed in JP 11-84126 A. However, this composition gives insufficient strength of the photocured film so that it is not practically usable.

As described above, due to a seemingly self-contradictory object of imparting photocurability to a resin composition having optically opaque property that is essentially incompatible with photoreactivity, it has been difficult to realize a practically usable resin black matrix.

Further, in a case where a color filter is produced by using a black matrix formed by forming the above-mentioned thin film of a metal such as chromium oxide by a photolithographic method, the metal thin film has high reflectivity on its surface so that when intense external light is applied to the filter, it produces intense reflected light so that the display quality is considerably reduced.

Studies on resin matrices have been made to solve the above-mentioned problems of the metal thin film, but no practically usable resin matrices have been obtained yet because of the reasons as described above.

An object of the present invention is to provide a resist material (a coloring composition a photosensitive coloring composition) for color filters that is free of the above-mentioned problems and enables forming a thin film or pattern having high optically opaque property easily by a photolithographic method and having sufficient sensitivity, developability and durability.

In particular, an object of the present invention is to provide a resist material for color filters containing black colorant and to enable production of a resin black matrix for color filters having low reflectivity with high precision and at low costs. Further, an object of the present invention is to obtain high image quality of color filters that are formed from a chromium free raw material, by forming a black matrix from a resin.

Furthermore, an object of the present invention is to provide a color filter having a resin black matrix that can be practically used. For this purpose, it is also an object of the present invention to provide a method of improving the dispersibility of the pigment in a coloring composition and improving photosensitivity of the photosensitive coloring composition for color filters.

Furthermore, an object of the present invention is to provide a modified carbon black having excellent dispersibility, high optically opaque property and photosensitivity by a simple operation at ambient temperature and to provide a photosensitive black resin composition suitable for a black matrix resist for color filters that can form a black matrix being high in dispersion stability, resolution, and photosensitivity and low in reflectivity by using such a modified carbon black. Also, an object of the present invention is to provide a black matrix resist using the photosensitive black resin composition and a black matrix using the black matrix resist.

### DISCLOSURE OF THE INVENTION

As a result of extensive studies, the inventors of the present invention have found that use of a resin having both an amido group and a carboxyl group as a binder resin gives rise to a coloring composition and a photosensitive coloring composition for color filters that have high optically opaque property and high sensitivity at the same time and are suitable for forming a black matrix having high durability and low reflectivity.

The inventors of the present invention have also found that treatment of a carbon black with a compound having an ethylenically unsaturated group and an isocyanate group in a molecule can give rise to a modified carbon black with a radical polymerizable group having excellent dispersion stability and that use of the modified carbon black can provide a photosensitive black resin composition excellent in carbon black dispersion stability, resolution and photosensitively. Further, the inventors have verified that a black matrix resist composition using the photosensitive black resin composition can form a black matrix having low reflectivity.

That is, the present invention has the following constituent elements.

1. A coloring composition characterized by comprising (A) a binder resin having an amido group and a carboxyl group, and (B) a coloring material.

2. A coloring composition according to 1 above, further comprising (C) an organic solvent.

3. A coloring composition according to 1 above, wherein the binder resin (A) having an amido group and a carboxyl group is an acrylic copolymer obtained by copolymerizing (a) 2 to 40 mass % of an ethylenically unsaturated monomer containing an amido group, (b) 2 to 40 mass % of an ethylenically unsaturated monomer containing a carboxyl group, and (c) 20 to 96 mass % of an ethylenically unsaturated monomer other than the (a) and (b).

4. A coloring composition according to 3 above, wherein the ethylenically unsaturated monomer (a) containing an amido group is at least one compound selected from the group consisting of N-(meth) acryloylmorpholine, N-vinylpyrrolidone and N-vinylcaprolactam.

5. A coloring composition according to any one of 1 to 4 above, further comprising (A′) an epoxy(meth)acrylate resin.

6. A coloring composition according to 5 above, wherein the epoxy(meth)acrylate resin (A′) is novolak epoxy(meth)acrylate resin having a carboxyl group.

7. A coloring composition according to 6 above, wherein the novolak epoxy (meth) acrylate resin having a carboxyl group has the number of phenyl nuclei of 4 to 7.

8. A coloring composition according to 6 or 7 above, wherein the novolak epoxy (meth) acrylate resin having a carboxyl group has an acid value of 10 to 150 mgKOH/g.

9. A coloring composition according to any one of 6 to 8 above, wherein the novolak epoxy(meth)acrylate resin having a carboxyl group has cresol novolak epoxy(meth)acrylate resin having a carboxyl group.

10. A coloring composition according to any one of 5 to 9 above, wherein a blending ratio of the binder resin (A) having an amido group and a carboxyl group to the epoxy(meth) acrylate resin (A′) is from 30:70 to 90:10 in a mass ratio.

11. A coloring composition according to any one of 5 to 10 above, comprising: 10 to 40 mass % of the binder resin (A) having an amido group and a carboxyl group; 10 to 40 mass % of the epoxy(meth)acrylate resin (A′); and 20 to 80 mass % of the coloring material (B), provided that a sum of (A), (A′) and (B) is 100 mass %.

12. A coloring composition according to any one of 1 to 11 above, wherein the coloring material (B) is a black pigment.

13. A coloring composition according to 12 above, wherein the black pigment is a carbon black.

14. A coloring composition according to 13 above, wherein the carbon black is a modified carbon black treated with a compound having an isocyanate group and an ethylenically unsaturated bond in a molecule.

15. A coloring composition according to 14 above, wherein the modified carbon black is a modified carbon black obtained by treating 100 mass parts of carbon black with from 0.5 to 50 mass parts of a compound having an isocyanate group and an ethylenically unsaturated bond in a molecule.

16. A coloring composition according to 14 or 15 above, wherein the compound having an isocyanate group and an ethylenically unsaturated bond in a molecule is 2-methacryloyloxyethyl isocyanate.

17. A coloring composition according to 13 above, wherein the carbon black is a modified carbon black having a 2-methacryloyloxyethylcarbamoyl group.

18. A method of producing a coloring composition according to any one of 1 to 17 above.

19. A photosensitive coloring composition for color filters comprising a coloring composition according to any one of 1 to 17 above.

20. A photosensitive coloring composition for color filters according to 19 above, further comprising (D) a photopolymerization initiator.

21. A photosensitive coloring composition for color filters according to 20 above, wherein the photopolymerization initiator comprises (D) comprises at least one member selected from the group consisting of:

(i) a hexaarylbiimidazole compound;

(ii) a triazine compound;

(iii) an aminoacetophenone compound; and

(iv) a combination of a sensitizer and an organoboron salt compound of a general formula (1)

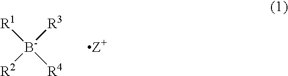

(wherein R¹, R², R³ and R⁴ represent alkyl, aryl, aralkyl, alkenyl, alkynyl, silyl or heterocyclic group, each of which may independently have a substituent group, or a halogen atom, Z⁺ represents any cation).

22. A photosensitive coloring composition for color filters according to 20 or 21 above, wherein each composition comprises the following contents of:

(A) 8 to 30 mass % of a binder resin having an amido group and a carboxyl group;

(A′) 8 to 30 mass % of an epoxy(meth)acrylate resin;

(B) 25 to 60 mass % of a coloring material; and

(D) 2 to 25 mass % of a photopolymerization initiator,

provided that a sum of the components (A), (A′), (B) and (D) is 100 mass %.

23. A photosensitive coloring composition for color filters, according to 20 above, further comprising (E) an ethylenically unsaturated monomer.

24. A photosensitive coloring composition for color filters according to 23 above, wherein each composition comprises the following contents of:

(A) 10 to 40 mass % of a binder resin having an amido group and a carboxyl group alone or 10 to 40 mass % of a combination of (A) a binder resin having an amido group and a carboxyl group and (A′) an epoxy(meth)acrylate resin;

(B) 25 to 60 mass % of a coloring material;

(D) 2 to 25 mass % of a photopolymerization initiator; and

(E) 5 to 20 mass % of an ethylenically unsaturated monomer,

provided that a sum of the components (A), (A′), (B), (D) and (E) is 100 mass %.

25. A photosensitive coloring composition for color filters according to 20 or 23 above, further comprising (F) a poly thiol as a chain transfer agent.

26. A photosensitive coloring composition for color filters according to 25 above, wherein a ratio of the poly thiol (F) to the photopolymerization initiator (D) is 10:1 to 1:10. 27. A photosensitive coloring composition for color filters, according to 25 or 26 above, wherein each composition comprises the following contents of:

(A) 10 to 40 mass % of a binder resin having an amido group and a carboxyl group alone or 10 to 40 mass % of a combination of (A) a binder resin having an amido group and a carboxyl group and (A′) an epoxy(meth)acrylate resin;

(B) 25 to 60 mass % of a coloring material;

(D) 2 to 20 mass % of a photopolymerization initiator;

(E) 5 to 20 mass % of an ethylenically unsaturated monomer; and

(F) 2 to 20 mass % of a poly thiol, provided that a sum of the components (A), (A′), (B), (D), (E) and (F) is 100 mass %.

28. A photosensitive coloring composition for color filters according to 25 or 26 above, wherein the composition comprises the following contents of:

(A) 8 to 30 mass % of a binder resin having an amido group and a carboxyl group;

(A′) 8 to 30 mass % of an epoxy(meth)acrylate resin;

(B) 25 to 60 mass % of a coloring material;

(D) 2 to 20 mass % of a photopolymerization initiator; and

(F) 2 to 20 mass % of a poly thiol;

provided that a sum of the components (A), (A′), (B), (D), and (F) is 100 mass %.

29. A photosensitive coloring composition for color filters according to any one of 19 to 28 above, characterized in that the composition requires a light exposure amount of 200 mJ/cm² or less for curing.

30. A method of producing a photosensitive coloring composition for color filters according to any one of 19 to 29 above.

31. A color filter characterized by using a photosensitive coloring composition for color filters according to any one of 19 to 29 above.

32. A color filter characterized by forming a black matrix using a photosensitive coloring composition for color filters containing a black pigment according to any one of 19 to 29 above.

33. A color filter according to 32 above, wherein the black pigment is a carbon black.

34. A color filter according to 33 above, wherein the carbon black is a modified carbon black treated with a compound having an isocyanate group and an ethylenically unsaturated bond in a molecule.

35. A method of producing a color filter, characterized by using a photosensitive coloring composition for color filters according to any one of 19 to 29 above.

36. A method of forming a black matrix for color filters, characterized by using a photosensitive coloring composition for color filters containing a black pigment according to any one of 19 to 29 above.

37. A method of forming a black matrix for color filters according to 36 above, wherein the black pigment is a carbon black.

38. A method of forming a black matrix for color filters according to 37 above, wherein the carbon black is a modified carbon black treated with a compound having an isocyanate group and an ethylenically unsaturated group in a molecule.

39. A black matrix resist composition for color filters, characterized by comprising a photosensitive coloring composition for color filters containing a black pigment according to any one of 19 to 29 above.

40. A black matrix formed by using a black matrix resist composition for color filters according to 39 above.

Further, the present invention includes a method of improving the dispersible of a coloring material, a method of improving the photosensitivity of a photosensitive coloring material, a modified carbon black, a dispersion of the same and a method of producing them having the following constituent elements.

41. A method of improving the dispersibility of a coloring material in a coloring composition characterized by using the component (A).

42. A method of improving the dispersibility according to 41 above, wherein the coloring material is a black pigment.

43. A method of improving the dispersibility according to 42 above, wherein the black pigment is a carbon black.

44. A method of improving the dispersibility according to 43 above, wherein the carbon black is a modified carbon black treated with a compound having an isocyanate group and an ethylenically unsaturated bond in a molecule.

45. A method of improving the photosensitivity of a photosensitive coloring composition for color filters, characterized by using a binder resin comprising the component (A) and optionally the component (A′).

46. A method of improving the photosensitivity of a photosensitive coloring composition for color filters according to 45 above, wherein the photosensitive coloring composition comprises a black pigment.

47. A method of improving the photosensitivity of a photosensitive coloring composition for color filters according to 46 above, wherein the black pigment is a carbon black.

48. A method of improving the photosensitivity of a photosensitive coloring composition for color filters according to 47 above, wherein the carbon black is a modified carbon black treated with a compound having an isocyanate group and an ethylenically unsaturated bond in a molecule.

49. A modified carbon black treated a carbon black with a compound having an isocyanate group and an ethylenically unsaturated bond in a molecule.

50. A modified carbon black according to 49 above, wherein 100 mass parts of the carbon black is treated with 0.5 to 50 mass parts of the compound having an isocyanate group and an ethylenically unsaturated group in a molecule.

51. A modified carbon black according to 49 or 50 above, wherein the compound having an isocyanate group and an ethylenically unsaturated bond in a molecule is 2-methacryloyloxyethyl isocyanate.

52. A modified carbon black having a 2-methacryloyloxyethylcarbamoyl group.

53. A method of producing a modified carbon black, characterized by treating a carbon black with a compound having an isocyanate group and an ethylenically unsaturated bond in a molecule.

54. A method of producing a modified carbon black, characterized by treating 100 mass parts of the carbon black with 0.5 to 50 mass parts of the compound having an isocyanate group and an ethylenically unsaturated bond in a molecule.

55. A method of producing a modified carbon black, characterized by treating a carbon black with 2-methacryloyloxyethyl isocyanate.

56. A method of producing a modified carbon black according to any one of 53 to 55 above, wherein the treatment is performed while pulverizing the carbon black.

57. A modified carbon black dispersion characterized by comprising a modified carbon black according to any one of 49 to 52 above.

58. A modified carbon black dispersion according to 57 above, further comprising an organic solvent.

59. A modified carbon black dispersion according to 58 above, further comprising a polymer dispersant.

60. A method of producing a modified carbon black dispersion, characterized by treating a carbon black with a compound having an isocyanate group and an ethylenically unsaturated bond in a molecule in an organic solvent.

61. A method of producing a modified carbon black dispersion according to 60 above, wherein the treatment is performed while dispersing the carbon black.

62. A method of producing a modified carbon black dispersion according to 60 or 61 above, characterized in that the compound having an isocyanate group and an ethylenically unsaturated bond in a molecule is 2-methacryloyloxyethyl isocyanate.

### DETAILED DESCRIPTION OF THE INVENTION

Hereinafter, the present invention will be described in detail. In the following description, “parts” and “percentages (%)” expressing ratios are based on mass unless otherwise specifically indicated.

(Definitions of Terms)

Herein, the term “(meth)acrylic acid” is used to include one or both of acrylic acid and methacrylic acid and the term “(meth)acryloyl” is used to include one or both of acryloyl and methacryloyl.

(I) Coloring Composition

The coloring composition of the present invention is a composition comprising a coloring material and a specific binder resin having dispersed the coloring material therein. The coloring composition may contain an organic solvent or a dispersant. The photosensitive coloring composition for color filters according to the present invention is a blend of a coloring composition, a photopolymerization initiator and an organic solvent for adjusting the concentration, viscosity an the like. The composition may contain an ethylenically unsaturated monomer.

The binder resin (A) used in the present invention is a binder resin having an amido group and a carboxyl group. Its having a carboxyl group improves the solubility in an alkali aqueous solution (alkali developability) and its having an amido group improves the dispersibility of the pigment and also improves the compatibility with other resins as well as photosensitivity.

The binder resin in a coloring composition is a component mainly responsible for the determination of various properties of the resist, such as film strength, heat resistance, adhesion to the substrate and solubility in an alkali aqueous solution (alkali developability). Any binder resin that has an amido group and a carboxyl group in the molecule may be used without any limitation. However, in consideration of obtaining a coating film having excellent properties of the resultant resist, such as film strength, heat resistance and adhesion to the substrate, and for its superior photosensitivity and superior dispersibility of a carbon black, preferred is an acrylic copolymer obtained by copolymerizing (a) an ethylenically unsaturated monomer containing an amido group, (b) an ethylenically unsaturated monomer containing a carboxyl group, and (c) an ethylenically unsaturated monomer other than the (a) and (b).

Acrylic copolymers can give high film strength and high heat resistance so that acrylic copolymers obtained by copolymerizing an ethylenically unsaturated monomer containing a carboxyl group such as (meth) acrylic acid with alkyl (meth) acrylate or the like have been the preferred choice for color filter resists. The inventors of the present invention have found that further copolymerization with (a) an ethylenically unsaturated monomer having an amido group improves the dispersibility of the coloring material such as carbon black and at the same time increases the photosensitivity of the coloring composition.

Further, since the above-mentioned acrylic copolymer is excellent in the dispersibility of carbon black as a coloring material, use of it can reduce the blending amount of a dispersant that will have to be added to the coloring composition and otherwise gives adverse influences on the physical properties of the resist.

Specific examples of amide group-containing ethylenically unsaturated monomers (a) include (meth)acrylamide, N,N-dimethyl (meta)acrylamide, N,N-diethyl (meth)acrylamide, N,N-di-n-butyl (meth)acrylamide, N,N-dimethylaminopropyl (meth) acrylamide, N-methyl (meth)acrylamide, N-ethyl (meth)acrylamide, N-isopropyl (meth)acrylamide, N-n-butyl (meth)acrylamide, N-tert-butyl (meth) acrylamide, N-(1,1′-dimethyl-2-phenyl)-ethyl (meth) acrylamide, N-methylol (meth)acrylamide, N-diphenylmethyl (meth)acrylamide, N-cyclohexyl (meth)acrylamide, N-(1-methylbutyl) (meth)acrylamide, diacetone (meth)acrylamide, N-vinyl acetamide and N-methyl-N-vinylacetamide, N-vinylpyrrolidone, N-vinylcaprolactam, N-(meth)acryloylmorpholine, and the like. N-vinylpyrrolidone, N-vinylcaprolactam and N-(meth)acryloylmorpholine are particularly preferred for the coloring composition according to the present invention from the viewpoint of the photosensitivity and the dispersion property of the coloring materials (in particular, black pigments and carbon blacks).

Carboxyl group-containing ethylenically unsaturated monomers (b) are used to give the alkaline developing property to the acrylic copolymer. As specific examples of carboxyl group-containing ethylenically unsaturated monomer, there are exemplified (meth)acrylic acid, 2-(meth) acryloyloxyethyl-succinic acid, 2-(meth) acryloyloxyethylphthalic acid, (meth)acryloyloxyethylhexahydrophtalic acid, (meth)acrylic acid dimer, maleic acid, crotonic acid, itaconic acid, fumaric acid, and the like.

Ethylenically unsaturated monomers. (c) in addition to a) and b) are used to control the film strength and the dispersion property of pigments. As specific examples of ethylenically unsaturated monomers (c), there are exemplified vinyl compounds such as styrene, α-methylstyrene, (o, m, p-)hydroxystyrene and vinyl acetate; and (meth) acrylates such as methyl (meth) acrylate, ethyl (meth)acrylate, n-propyl (meth)acrylate, isopropyl (meth)acrylate, n-butyl (meth)acrylate, tert-butyl (meth) acrylate, n-hexyl (meth)acrylate, cyclohexyl (meth) acrylate, benzyl (meth)acrylate, phenoxyethyl (meth)acrylate, isobornyl (meth) acrylate, tetrahydrofurfuryl (meth)acrylate, (meth)acrylonitrile, glycidyl-(meth)acrylate, allyl glycidyl ether, 2-hydroxyethyl (meth)acrylate, 2-hydorxypropyl (meth)acrylate, N,N-dimethylaminoethyl (meth)acrylate, trifluoroethyl acrylate, 2,2,3,3,-tetrafluoropropyl (meth)acrylate, perfluorooctylethyl (meth)acrylate, and the like.

In the coloring composition of the present invention, the acrylic copolymer (A) having an amido group and a carboxyl group in the molecule used can be prepared by radical polymerization of the above-mentioned components (a), (b) and (c) in an organic solvent by a known method. The ratio of the copolymerization components are 2 to 40 mass % of (a), 2 to 40 mass % of (b), and 20 to 96 mass % of (c), preferably 4 to 30 mass % of (a), 4 to 30 mass % of (b), and 40 to 92 mass % of (c), and more preferably 6 to 25 mass % of (a), 6 to 25 mass % of (b), and 50 to 88 mass % of 5 (c).

If the copolymerization component ratio of the ethylenically unsaturated monomer containing an amido group (a) is less than 2 mass %, no improvement in photosensitivity and dispersibility of coloring material (in particular black pigment, carbon black) is observed. On the other hand, if the ratio exceeds 40 mass %, then the rate of alkali development is too high to be practically usable. Further, if the copolymerization component ratio of the ethylenically unsaturated monomer containing a carboxyl group (b) is less than 2 mass %, the alkali developability is considerably decreased while the copolymerization component ratio of the component (b) exceeding 40 mass % results in an alkali development rate too high to be practically usable.

In addition, acrylic copolymers having an ethylenically unsaturated group in the side chain may be used without problems. These acrylic copolymers can be obtained by reacting a portion of carboxyl groups in the side chains of the acrylic copolymer prepared by copolymerization of the above-mentioned monomers with the epoxy group of a compound having an epoxy group and an ethylenically unsaturated group in the molecule, such as glycidyl (meth)acrylate and allyl glycidyl ether, or reacting a portion or all of the hydroxyl groups in the acrylic copolymer with the isocyanate group of a compound having an isocyanate group and an ethylenically unsaturated group in the molecule.

The preferred molecular weight of the acrylic copolymer as mentioned above is in a range of from 1, 000 to 500,000, preferably from 3,000 to 200,000, as weight average molecular weight expressed in terms of polystyrene as measured by gel permeation chromatography. If the molecular weight is less than 1,000, the resultant film has greatly decreased film strength. On the other hand, the molecular weight of exceeding 500,000 results in a considerably decreased alkali developability.

Further, in the present invention, acrylic copolymers having a carboxyl group but having no amido group may also be used in combination.

In the coloring composition of the present invention, in order to further increase the photosensitivity of a photosensitive coloring composition for color filters containing it, an epoxy (meth) acrylate resin (A′) may be used in combination.

The epoxy (meth) acrylate resin (A′) has an unsaturated group in the molecule so that it is very effective for increasing the photosensitivity of the composition and at the same time it improves the durability of the coating as compared with the case where an ethylenically unsaturated monomer, that is, monomer is used. It is preferred that a polybasic acid anhydride is added to the hydroxyl groups of the epoxy (meth) acrylate resin to impart the resin with a carboxyl group, thereby increasing the alkali developability.

The epoxy (meth) acrylate resin (A′) having a carboxyl group can be obtained by adding an unsaturated monocarboxylic acid to the epoxy group of the epoxy resin and further reacting the resin with a polybasic acid anhydride.

As the epoxy resins which can be used, there are exemplified bisphenol A type epoxy resins, bisphenol F type epoxy resins, bisohenol S type epoxy resins, novolak epoxy resins, (o, m, p-) cresol novolak-resins, phenol novolak epoxy resins, naphthol modified novolak epoxy resins, halogenated phenol novolak epoxy resins, and the like. The preferred molecular weight of the above-mentioned epoxy resins is in the range of 300 to 100,000 with respect to the weighted average molecular weight as measured using GPC. When the molecular weight is less than 300, the film strength is reduced. To the contrary, the resin having the molecular weight beyond 100,000 is easy to be gelled at the time of the addition reaction of the unsaturated monocarboxylic acid, thereby it is likely to become difficult to produce the carboxy group-containig epoxy(meth)acrylate resins.

The examples of the unsaturated monocarboxylic acids used to react with the epoxy resin to synthesize the epoxy (meth)acrylate resin include (meth)acrylic acid, 2-(meth)acryloyloxyethylsuccinic acid, 2-(meth)acryloyloxy-ethylphthalic acid, (meth)acryloyloxyethylhexahydrophtalic acid, (meth)acrylic acid dimer, itaconic acid, crotonic acid, cinnamic acid, and the like. Of those, acrylic acid is particularly preferred because of its great reactivity.

The addition reaction of the unsaturated monocarboxylic acid to the epoxy resin can be performed using known procedures. For example, the reaction can be carried out in the presence of a catalyst for esterification at the temperature from 50 to 150° C. As the catalyst for esterification, tertiary amines such as triethylamine, trimethylamine, benzyldimethylamine and benzyldiethylamine; quaternary ammonium salts such as tetramethylammonium chloride, tetraethylammonium chloride and dodecyltrimethyl ammonium chloride, or the like can be used.

The addition amount of the unsaturated monocarboxylic acid is preferably in a range of from 0.5 to 1.2 equivalents, preferably in a range of from 0.7 to 1.1 equivalents, per equivalent of the epoxy group of the epoxy resin. If the addition amount of the unsaturated monocarboxylic acid is outside the above-mentioned range, the curing properties tend to be deteriorated.

The polybasic acid anhydride to be further added to the epoxyresin to which the unsaturated monocarboxylic acid has been added includes maleic anhydride, succinic anhydride, itaconic anhydride, phthalic anhydride, tetrahydrophthalic anhydride, hexahydrophthalic anhydride, pyromellitic anhydride, trimellitic anhydride, benzophenonetetracarboxylic dianhydride, and the like. The addition reaction of polybasic acid anhydride may be performed by using a known technique. The adducts can be obtained by continuous reaction under the same conditions as the addition reaction of unsaturated monocarboxylic acid. The addition amount of polybasic anhydride is such that the acid value of resin is in a range of from 10 to 150 mgKOH/g, preferably in a range of from 20 to 90 mgKOH/g, and more preferably 30 to 80 mgKOH/g. If the acid value is smaller than that described above, the alkali developability becomes poor. On the other hand, the acid value exceeding the above-mentioned range gives a development rate too high to be practically usable.

The epoxy (meth) acrylate resin (A′) is preferably a novolak epoxy(meth)acrylate resin having a carboxyl group and more preferably (o, m, p-)cresol novolak epoxy(meth)acrylate resin having a carboxyl group. Use of novolak epoxy(meth)acrylate resin having a carboxyl group provides excellent developability and a considerable improvement in photosensitivity.

The epoxy resin used for preparing the novolak epoxy(meth)acrylate resin includes novolak epoxy resins, (o, m, p-)cresol novolak epoxy resins, phenol novolak epoxy resins, naphthol-modified novolak epoxy resins, halogenated phenol novolak epoxy resins and the like.

From the viewpoint of compatibility with the acrylic copolymer (A) having a carboxyl group, the epoxy resin having a phenyl nucleus number of 4 to 7 is particularly preferred. If the phenyl nucleus number exceeds 7, the epoxy resin has a decreased compatibility with the acrylic copolymer having a carboxyl group and the resultant black matrix will have high reflectivity. On the other hand, the phenyl nucleus number of smaller than 4 will give rise to decreased photosensitivity.

When the epoxy(meth)acrylate resin (A′) is used in combination, the blending ratio of the acrylic copolymer (A) having an amido group and a carboxyl group to the epoxy(meth)acrylate resin (A′) is preferably (A): (A′)=30:70 to 90:10 and more preferably (A): (A′)=40:60 to 85:15 (ratio by mass) so as to balance film strength and photosensitivity. If the blending ratio of the acrylic copolymer is smaller than 30:70, then the film strength is decreased. On the other hand, the blending ratio of the epoxy(meth)acrylate resin smaller than 90:10 will give rise to insufficient photosensitivity.

In the present invention, the coloring material (C) that can be used may be any desired organic and inorganic pigments or dyes of yellow, red, blue, green and the like colors. In particular, the coloring composition of the present invention can be made to have very high sensitivity so that it can be suitably applied to black pigments that are considered to have the highest optically opaque property and hence generally the worst photosensitivity accordingly. Therefore, the coloring composition of the present invention can be particularly suitably used for a black matrix resist for use in color filters.

In the present invention, the term “black pigment” means a pigment comprising at least one black component, and the black pigment may further comprise other black component(s) and/or colored (red, green, blue) inorganic or organic pigments.

Specific examples of the black component of the black pigment include carbon black, acetylene black, lamp black, carbon nanotube, graphite, iron black, iron oxide black pigment, aniline black, cyanine black, titanium black and the like. Among them, carbon black is most preferred in consideration of the optically opaque property and image properties.

The carbon black that can be used in the present invention may be any commercially available one. Here, the term “carbon black” refers to black or grayish black powder generated by incomplete combustion or thermal decomposition of an organic matter, the main component of which is carbon. The micro state of the surface of carbon black may vary depending on the production method thereof. The production method for producing carbon black includes a channel method, a furnace method, a thermal method, a lamp black method, an acetylene method and the like. In the present invention, any carbon black regardless of the production method may be used without problems.

In consideration of the dispersibility and resolution, a preferred particle diameter of the carbon black is in a range of from 5 to 200 nm. If the particle diameter is less than 5 nm, uniform dispersion is difficult to obtain and if it is more than 200 nm, the resolution will be decreased. A more preferred particle diameter is in a range of from 10 to 100 nm.

Examples of carbon blacks include the following carbon black: Printex95, Printex90, Printex85, Printex75, Printex55, Printex45, Printex40, Printex30, Printex3, PrintexA, PrintexG, Special Black550, Special Black350, Special Black 250, Special Black100 and Special Black4 (manufactured by Degussa AG); MA7, MA8, MA11, MA100, MA220, MA230, #52, #50, #47, #45, #2700, #2650, #2200, #1000, #990 and #900 (manufactured by MITSUBISHI CHEMICAL CORPORATION); Monarch460, Monarch430, Monarch280, Monarch120, Monarch800, Monarch4630, REGAL99, REGAL99R, REGAL415, REGAL415R, REGAL250, REGAL250R, REGAL330 and BLACK PEAR LS480 (manufactured by Cabot Corporation); and RAVEN11, RAVEN15, RAVEN30, RAVEN35, RAVEN40, RAVEN410, RAVEN420, RAVEN450, RAVEN500, RAVEN780, RAVEN850, RAVEN890H, RAVEN1000, RAVEN1020, RAVEN1040, RAVEN1060, RAVEN1080 and RAVEN1100 (manufactured by. Columbian Chemicals Company).

In the present invention, a modified carbon black comprising the carbon black as mentioned above further treated with a compound having an isocyanate group and an ethylenically unsaturated bond in the molecule might be used. The modified carbon black can be readily prepared by suspending carbon black in an organic solvent having no active hydrogen, adding a compound having an isocyanate group and an ethylenically unsaturated bond in the molecule to the suspension and treating while dispersing the carbon black by using a disperser such as a paint conditioner, beads mill or the like. It is preferred to use SUS beads or the like in order to reduce the particle diameter of carbon black, in particular to allow the reaction to proceed so that the carbon black particles are in a state close to primary particles. It may be presumed that as a result of this treatment, addition of an isocyanate group to a functional group having active hydrogen, such as a hydroxyl group, on the surface of the carbon black, which makes the compound having an isocyanate group and an ethylenically unsaturated bond in the molecule to bind to the surface of the carbon black particles.

The temperature at which the carbon black is treated may be any temperature between 0° C. and the boiling point of the solvent used, preferably from 10 to 60° C., and more preferably from 20 to 30° C. (room temperature in an ordinary sense).

The treating time, which may vary depending on the catalyst used as will be described later, maybe 0.5 hour or more, preferably not shorter than 1 hour and not longer than 8 hours, and more preferably not shorter than 2 hours and not longer than 5 hours.

Upon performing the treatment, optionally a dispersant may be added as appropriate in order to prevent agglomeration of carbon black particles and allow the compound having an isocyanate group and an ethylenically unsaturated bond in the molecule to uniformly add to the surface of the carbon black particles. To complete the reaction in a short time, a urethane bond-forming catalyst that promotes the reaction between the isocyanate group and hydroxyl group may be added.

Specific examples of the compound having an isocyanate group and an ethylenically unsaturated bond in the molecule used in the present invention include 2-methacryloyloxyethyl isocyanate (Karenz MOI, manufactured by Showa Denko K. K., hereinafter sometimes referred to as “MOI”), methacryl isocyanate, m-isopropenyl-α,α-dimethylbenzyl isocyanate, a 1:1 (by molar ratio) reaction product between (meth) acrylic acid ester containing a hydroxyl group and a diisocyanate compound and the like.

Examples of the hydroxyl group-containing (meth)acrylic acid ester herein include 2-hydroxyethyl (meth)acrylate, 2-hydroxypropyl (meth) acrylate, 2-hydroxybutyl (meth) acrylate, 4-hydroxybutyl (meth)acrylate, 4-hydroxycyclohexyl (meth)acrylate, 2-hydroxy-3-phenyloxypropyl (meth)acrylate, 3-chloro-2-hydroxybutyl: (meth)acrylate, polyethylene glycol mono (meth) acrylate, polypropylene glycol mono (meth) acrylate, caprolactone modified hydroxyethyl (meth)acrylate, mono (meth) acrylic acid ester of diol, which is composed of the condensate of phthalic anhydride and ethylene glycol, mono (meth)acrylic acid ester of diol, which is composed of the condensate of phthalic anhydride and propylene glycol, and the like.

Moreover, examples of the diisocyanate compound include hexamethylene diisocyanate, lysine diisocyanate, isophorone diisocyanate, dicyclohexylmethane-4,4′-diisocyanate, dicyclohexylmethane-2,4′-diisocyanate, ω,ω′-diisocyanate dimethylcyclohexane, 2,4-tolylene diisocyanate, 2,6-tolylene diisocyanate, 1,3-xylylene diisocyanate, 1,4-xylylene diisocyanate, diphenylmethane-4,4′-diisocyanate, diphenyl-methane-2,4′-diisocyanate, 1,5-naphthalene diisocyanate, tolidine diisocyanate, tetramethylxylene diisocyanate, and the like, and an adduct obtained by reacting the above-mentioned diisocyanate with a low molecular weight diol such as ethylene glycol, diethylene glycol, propylene glycol, dipropylene glycol and 1,3-butanediol in excess of equivalent.

When the hydroxyl group-containing (meth)acrylic acid ester is reacted with the diisocyanate compound, a known catalyst for formation of urethane bond may be added. Examples of such catalysts include known catalysts for formation of urethane bond such as tertiary amines (for example, triethyl amine, triethylenediamine, triethylamine, 1,4-diazabicyclo[2.2.2]-octane, 1,8-diazabicyclo[5.4.0]-7-undecene, and the like), and organotin compounds (for example, dibutyltin dilaurate, tin octylate, and the like).

In the present invention, as the compound having an isocyanate group and an ethylenically unsaturated bond in the molecule, 2-methacryloyloxyethyl isocyanate (MOI) is particularly preferred from the viewpoint of workability upon preparing the modified carbon black and the stability and photosensitivity of a photosensitive black resin composition prepared from the modified carbon black.

The blending ratio of the compound having an isocyanate group and an ethylenically unsaturated bond in the molecule to the carbon black is from 0.5 to 50 mass parts per 100 mass parts of the carbon black. If the ratio is below 0.5 mass parts, the dispersibility will be decreased so that the reflectivity and photosensitivity of the prepared photosensitive black resin composition will be decreased. The ratio above 50 mass parts results in an increase in the amount of the compound that cannot add to the surface of carbon black particles so that the stability of the resultant photosensitive resin composition will be decreased. The blending ratio of the compound to the carbon black is preferably from 1 to 40 mass parts and more preferably from 2 to 30 mass parts per 100 mass parts of the carbon black.

The organic solvent which can be used in the preparation of the modified carbon black according to the present invention may be any solvent so long as the solvents have no active hydrogen which is reactive with isocyanate group. Examples of such organic solvents include ethers such as diisopropyl ether, ethyl isobutyl ether and butyl ether; esters such as ethyl acetate, isopropyl acetate, butyl (n, sec, tert) acetate, amyl acetate, ethyl 3-ethoxypropionate, methyl 3-methoxypropionate, ethyl 3-methoxypropionate, propyl 3-methoxypropionate and butyl 3-methoxypropionate; ketones such as methyl ethyl ketone, isobutyl ketone, diisopropyl ketone, ethyl amyl ketone, methyl butyl ketone, methyl hexyl ketone, methyl isoamyl ketone, methyl isobutyl ketone and cyclohexanone; and ethylene glycol diethyl ether, ethylene glycol monomethyl ether acetate, ethylene glycol monoethyl ether acetate, diethylene glycol monoethyl ether acetate, propylene glycol monomethyl ether acetate, propylene glycol monoethyl ether acetate, dipropylene glycol monomethyl ether acetate, dipropylene glycol monoethyl ether acetate, and the like. Those solvents are desirably dried to use.

Examples of the catalyst which can be used in the preparation of the modified carbon black according to the present invention include known catalysts for formation of urethane bond such as tertiary amines (for example, triethylamine, triethylenediamine, triethylamine, 1,4-diazabicyclo[2.2.2]-octane, 1,8-diazabicyclo[5.4.0]-7-undecene, and the like), and organotin compounds (for example, dibutyltin dilaurate, tin octylate, and the like).

The dispersant that can be used in preparing the modified carbon black of the present invention is one having affinity for carbon black and includes, for example, nonionic, cationic and anionic surfactants, polymer dispersants and the like. Among them, the polymer dispersants are preferred. In particular, polymer dispersants having basic functional groups such as tertiary amino groups, nitrogen-containing heterocycles such as pyridine, pyrimidine and pyrazine ring can be advantageously used.

The carbon black as described above may be used in combination with other black or colored inorganic or organic pigments. The other pigments have lower optically opaque property and image properties, so that naturally, their mixing ratio is limited.

Moreover, the coloring composition and the photosensitive coloring composition according to the present invention can be also used without problem in the resist for RGB other than black matrixtes. As the pigments which can be used in the case, there are exemplified C. I. Pigment Yellow 20, 24, 86, 93, 109, 110, 117, 125, 137, 138, 147, 148, 153, 154 and 166; C. I. Pigment Orange 36, 43, 51, 55, 59 and 61; C. I. Pigment Red 9, 97, 122, 123, 149, 168, 177, 180, 192, 215, 216, 217, 220, 223, 224, 226, 227, 228 and 240; C. I. Pigment Violet 19, 23, 29, 30, 37, 40 and 50; C. I. Pigment Blue 15, 15:1, 15:4, 22, 60 and 64; C.I. Pigment Green 7; and C. I. Pigment Brown 23, 25 and 26, and the like, as represented in C. I. numbers.

In the coloring composition, the blending ratios of the respective components are as described below.

In a case where no epoxy(meth)acrylate resin (A′) is used, it is preferred that 20 to 80 mass % of the binder resin (A) having an amido group and a carboxyl group and 80 to 20 mass % of the coloring material (B) are mixed provided that the sum of the component (A) and the component (B) being 100 mass %.

In a case where the epoxy (meth) acrylate resin (A′) is used in combination, the binder resin (A) having an amido group and a carboxyl group is preferably in a ratio of from 10 to 40 mass % and more preferably from 12 to 30 mass %. If the ratio is less than 10 mass %, the film strength will be decreased and the ratio above 40 mass % will decrease the optically opaque property. The epoxy(meth) acrylate resin (A′) preferably has a ratio of from 10 to 40 mass % and more preferably from 15 to 30 mass %. If the ratio is less than 10 mass %, the photosensitivity will be decreased. On the other hand, the ratio above 40 mass % will decrease the optically opaque property. The coloring material (B) is preferably in a range of from 20 to 80 mass % and more preferably from 40 to 70 mass %. The ratio below 20 mass %, will make the optically opaque property be insufficient and the ratio above 80 mass % will make it impossible to stably disperse the coloring material.

(II) Photosensitive Coloring Composition

The photosensitive coloring composition of the present invention comprises the above-mentioned coloring composition and (D) a photopolymerization initiator, and optionally (E) ethylenically unsaturated monomer, (F) a poly thiol, and a hydrogen-donating compound, as necessary.

The photopolymerization initiator (D) in the photosensitive coloring composition of the present invention is a compound that generates radicals upon excitation by active rays to initiate the polymerization of ethylenically unsaturated bonds. The photopolymerization initiator used in the photosensitive coloring composition of the present invention must generate radicals under high optically opaque conditions so that one having high photosensitivity is used. Examples of such a photopolymerization initiator include (i) a hexaarylbiimidazole compound, (ii) a triazine compound, (iii) an aminoacetophenone compound, (iv) a combination of a sensitizer and an organoboron salt compound of a general formula (1) below, (v) an titanocene compound, and (vi) an oxadiazole compound. Preferably, (i) a hexaarylbiimidazole compound, (ii) a triazine compound, (iii) a aminoacetophenone compound, (iv) a combination of a sensitizer and an organoboron salt compound of the formula (1) may be used.

Specific examples of the hexaarylbiimidazole-based compound include 2,2′-bis(o-chlorophenyl)-4,4′,5,5′-tetraphenyl-1,2′-biimidazole, 2,2′-bis(o-bromophenol)-4,4′,5,5′-tetraphenyl-1,2′-biimidazole, 2,2′-bis(o-chloro-phenyl)-4,4′,5,5′-tetra(o,p-dichlorophenyl)-1,2′-biimidazole, 2,2′-bis(o,p-dichlorophenyl)-4,4′,5,5′-tetra(o,p-dichloro-phenyl)-1,2′-biimidazole, 2,2′-bis(o-chlorophenyl)-4,4′,5,5′-tetra(m-methoxyphenyl)-1,2′-biimidazole, 2,2′-bis(o-methyl-phenyl)-4,4′,5,5′-tetraphenyl-1,2′-biimidazole, and the like.

When the hexaarylbiimidazole-based compound is used, a benzophenone-based compound such as benzophenone, 2,4,6-trimethylbenzophenone, 4-phenylbenzophenone, 4,4′-bis (dimethylamino) benzophenone and 4,4,-bis(diethylamino)-benzophenone, or a thioxanthone-based compound such as 2,4-diethylthioxanthone, isopropylthioxanthone, 2,4-diisopropyl-thioxanthone and 2-chlorothioxanthone, or the like may be added as a sensitizing agent to enhance sensitivity.

As specific examples of the triazine-based compound, there are exemplified 2,4,6-tris(trichloromethyl)-s-triazine, 2,4,6-tris(tribromomethyl)-s-triazine, 2-propionyl-4,6-bis(trichlorommethyl)-s-triazine, 2-benzoyl-4,6-bis(trichloromethyl)-s-triazine, 2-(4-chlorophenyl)-4,6-bis(trichloromethyl)-s-triazine, 2,4-bis(4-methoxyphenyl)-6-trichloromethyl-s-triazine, 2-(4-methoxyphenyl)-2,6-bis(trichloromethyl)-s-triazine, 2-(4-methoxystyryl)-4,6-bis(trichloromethyl)-s-triazine, 2-(4-chlorostyryl)-4,6-bis(trichloromethyl)-s-triazine, 2-(4-aminophenyl)-4,6-bis(trichloromethyl)-s-triazine, 2,4-bis(3-chlorophenyl)-6-trichloromethyl-s-triazine, 2-(4-aminostyryl)-4,6-bis(dichloromethyl)-s-triazine, and the like.

As specific examples of the aminoacetophenone-based compound, there are exemplified 2-methyl-1-[4-(methylthio)-phenyl]-2-morpholinopropane-1-one and 2-benzyl-2-dimethyl-amino-1-(4-morpholinophenyl)-butanone-1.

In the photopolymerization initiator comprising a combination of a sensitizer and an organoboron salt compound of general formula (1) below, the quaternary organoboron salt compound is represented by general formula (1) below.

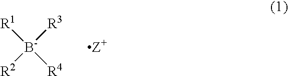

(wherein R¹, R², R³ and R⁴ independently represent an optionally substituted alkyl, aryl, aralkyl, alkenyl, alkynyl, silyl or heterocyclic group, or a halogen atom, Z⁺ represents any cation).

The quaternary organoboron salt compound alone absorbs ultraviolet rays and can generate radicals but a combination of it with a sensitizer can provide a very highly sensitive photopolymerization initiator.

The quaternary organoboron-based compound in the present invention is composed of a quaternary organoboron anion and any cation (Z⁺). R¹, R², R³ and R⁴ in the general formula (1) each independently represent alkyl group, aryl group, aralkyl group, alkenyl group, alkynyl group, silyl group or heterocyclic group. Those groups may have a substituent. Specific examples of such substituents include, but are limited to in the present invention, methyl group, ethyl group, n-propyl group, isopropyl group, n-butyl group, sec-butyl group, isobutyl group, tert-butyl group, n-octyl group, n-dodecyl group, cyclopentyl group, cyclohexyl group, phenyl group, tolyl group, xylyl group, anisyl group, biphenyl group, naphthyl group, benzyl group, phenethyl group, diphenylmethyl group, methoxy group, ethoxy group, n-propoxy group, isopropoxy group, n-butoxy group, sec-butoxy group, tert-butoxy group, methylenedioxy group, ethylenedioxy group, phenoxy group, naphthoxy group, benzyloxy group, methylthio group, phenylthio group, 2-furyl group, 2-thienyl group, 2-pyridyl group, fluoro group, and the like.

Specific examples of the quaternary organoboron anion in the gereral formula (1) include methyltriphenyl borate, n-butyltriphenyl borate, n-octyltriphenyl borate, n-dodecyltriphenyl borate, sec-butyltriphenyl borate, tert-butyltriphenyl borate, benzyltriphenyl borate, n-butyltri(p-anisyl) borate, n-octyltri(p-anisyl) borate, n-dodecyltri(p-anisyl)borate, n-butyltri(p-tolyl)borate, n-butyltri(o-tolyl) borate, n-butyltri(4-tert-butylphenyl) borate, n-butyltri(4-fluoro-2-methylphenyl)borate, n-butyltri(4-fluorophenyl) borate, n-butyltri(1-naphthyl) borate, ethyltri(1-naphthyl) borate, n-butyl tri[1-(4-methylnaphthyl)] borate, methyltri[1-(4-methylnaphtyl)] borate, triphenylsilyltriphenyl borate, trimethylsilyltriphenyl borate, tetra-n-butyl borate, di-n-butyldiphenylborate, tetrabenzylborate, and the like. The compound having structure wherein R¹ is alkyl group, and R², R³ and R⁴ are naphthyl group is advantageous to the present invention, since it keep the balance between stability and photoreactivity.

Furthermore, specific examples of Z⁺ in the general formula (1) include tetramethyl ammonium, tetraethyl ammonium, tetra-n-butyl ammonium, tetraoctyl ammonium, N-methylquinolium, N-ethylquinolium, N-methylpyridinium, N-ethylpyridinium, tetramethyl phosphonium, tetra-n-butyl phosphonium, trimethyl sulfonium, triphenyl sulufonium, trimethyl sulfoxonium, diphenyl iodonium, di(4-tert-butylphenyl) iodonium, lithium cation, sodium cation, and the like.

Any desired combinations of the anion and Za may be used in the present invention. However, the present invention is not limited to particular examples described above. Also, combinations of two or more of the quaternary boron salt compounds may be used.

The sensitizer used in combination with the quaternary organoboron salt compound may be any sensitizer that can absorb light and decompose the quaternary organoboron salt compound and compounds selected from benzophenone compounds, thioxanthone compounds, quinone compounds and cationic dyes represented by general formula (2) below may be suitably used:

D⁺+A⁻ (2)

(wherein D+represents a cation having a maximum absorption wavelength in a range of from 300 to 500 nm and A⁻ represents any desired anion).

As specific examples of the benzophenone-based compound, there are exemplified benzophenone, 4-methylbenzophenone, 2,4,6-trimethylbenzophenone, benzoil benzoic acid, 4-phenylbenzophenone, 3,3′-dimethyl-4-methoxybenzophenone, 4-benzoyl-4¹-methyldiphenyl sulfide, 4,4′-bis(N,N-dimethyl-amino)benzophenone, 4,4′-bis(N,N-diethylamino)benzophenone, (2-acryloyloxyethyl) (4-benzoylbenzyl) dimethylammonium bromide, 4-(3-dimethylamino-2-hydroxypropoxy)benzophenone, methochloride monohydrate, (4-benzoylbenzyl)trimethylammonium chloride, and the like.

Moreover, as specific examples of the thioxanthone-based compound, there are exemplified thionxanthone, 2,4-diethylthioxanthone, isopropylthioxanthone, 2,4-diisopropyl-thioxanthone, 2-chlorothioxanthone, 1-chloro-4-propoxy-thioxanthone, 2-(3-dimethylamino-2-hydroxypropoxy)-3,4-dimethyl-9H-thioxanthene-9-one methochloride, and the like.

Furthermore, specific examples of the quinone-based compound include 2-ethylanthraquinone, 9,10-phenanthrene-quinone, and the like.

Further, D⁺ in the cationic dye of the general formula (2) is a cation of the compound having a maximum absorption wavelength in a range of from 300 to 500 nm. Here, preferred examples of D⁺ include methine, polymethine, azamethine, and diazamethine compounds.

Specific examples of A⁻ in the gerenal formula (2) include halogen anions such as Cl⁻, Br⁻ and I⁻; sulfonate anions such as benzenesulfonate anion, p-toluenesulfonate anion, methane-sulfonate anion and 1-naphthalenesulfonate anion; borate anions such as tetraphenyl borate, tetraanisyl borate, n-butyltriphenyl borate, tetrabenzyl borate and tetrafluoro borate; and various anions such as ClO₄⁻, PF₆⁻, SbF₆⁻ and BF₄⁻. However, A⁻ is not limited ve-mentioned examples in the present invention. The of the cationic dye is specifically shown in the Table not limited to those examples in the present invention.

TABLE 1
Examples of Cation Dyestuff (D⁺ · A⁻)

| | | | Maximum Absorption Wavelength |
|---|---|---|---|
| Number | D⁺ | A⁻ | (Kind of Solvent used for Measurement) |
| 1 | 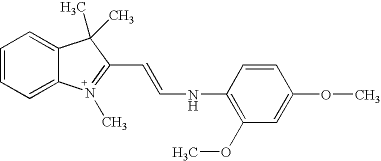 | Chloride anion | 422 nm (Acetonitrile) |
| 2 | 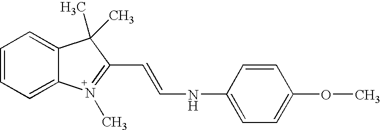 | Chloride anion | 412 nm (Ethanol) |
| 3 | 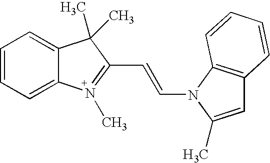 | Tetrafluoroborate anion | 418 nm (Acetonitrile) |
| 4 | 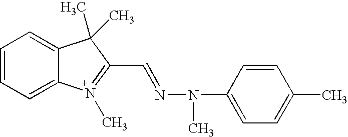 | 1-naphthalene- sulfonate anion | 435 nm (Acetonitrile) |
| 5 | 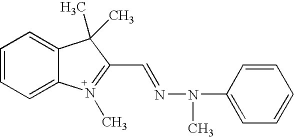 | 1-naphthalene- sulfonate anion | 427 nm (Acetonitrile) |
| 6 | 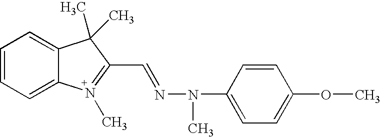 | Tetraphenylborate | 445 nm (Acetonitrile) |
| 7 | 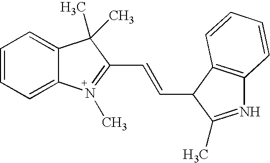 | Chloride anion | 497 nm (Dimethylsulfoxide) |

Those sensitizing agents maybe used alonei but if necessary, two or more of those agents may be mixed in any proportion to use.

As the titanocene-based compound, the compounds described in JP 59-152396 A, JP 61-151197 A, JP 63-10602 A, JP 63-41484 A, JP 2-291 A, JP 3-12403 A, JP 3-20293 A, JP 3-27393 A, JP 3-52050 A, JP 4-221958 A,-JP 4-21975 A, and the like can be used. Specifically, there are exemplified dicyclopentadienyl-Ti-dichloride, dicyclopentadienyl-Ti-diphenyl, dicyclopenta-dienyl-Ti-bis(2,3,4,5,6-pentafluorophenyl), dicyclopenta-dienyl-Ti-bis(2,3,5,6-tetrafluorophenyl), dicyclopentadienyl-Ti-bis(2,4,6-trifluorophenyl), dicyclopentadienyl-Ti-bis(2,6-difluorophenyl), dicyclopentadienyl-Ti-bis(2,4-difluoro-phenyl), bis(methylcyclopentadienyl)-Ti-bis(2,3,4,5,6-penta-fluorophenyl), bis(methylcyclopentadienyl)-Ti-bis(2,3,5,6-tetrafluorophenyl), bis(methylcyclopentadienyl)-Ti-bis(2,6-difluorophenyl), and the like.

Examples of the oxadiazole-based compound include 2-phenyl-5-trichloromethyl-1,3,4-oxadiazole, 2-(p-methyl-phenyl)-5-trichloromethyl-1,3,4-oxadiazole, 2-(p-methoxy-phenyl)-5-trichloromethyl-1,3,4-oxadiazole, 2-styryl-5-trichloromethyl-1,3,4-oxadiazole, 2-(p-methoxystyryl)-5-trichloromethyl-1,3,4-oxadiazole, 2-(p-butoxystyryl)-5-trichloromethyl-1,3,4-oxadiazole, and the like, which have a halomethyl group.

An ethylenically unsaturated monomer (E) can be formulated in the photosensitive coloring composition according to the present invention. The ethylenically unsaturated monomer is a compound polymerized with a radical generated from a photo-polymerization initiator on irradiation of an activated light ray. The compound having a low boiling point is volatilized at the time of drying solvents before exposure to light. As a result, the proportion of each component in the composition becomes changed, and the composition cannot display the desired property. Therefore, the compound having the boiling point of 150° C. or more is preferred. Specific examples of such compounds include compounds having one ethylenically unsaturated group in one molecule such as 4-tert-butylcyclohexyl (meth)acrylate, dicyclopentanyl (meth) acrylate, dicyclopentenyl (meth) acrylate, dicyclopentanyloxyethyl (meth)acrylate, dicyclopentenyl-oxyethyl (meth)acrylate, isobornyl (meth) acrylate, ethoxydiethylene glycol (meth)acrylate, methoxytriethylene glycol (meth) acrylate, methoxydipropylene glycol (meth) acrylate, phenoxyethyl (meth)acrylate, phenoxydiethylene glycol (meth)acrylate, tetrahydrofurfuryl (meth)acrylate, 2-hydroxyethyl (meth) acrylate, 2-hydroxypropyl (meth) acrylate, 2-hydroxy-3-phenoxypropyl (meth) acrylate, N,N-dimethylamino-ethyl-(meth) acrylate, N,N-dimethylaminopropyl (meth) acrylamide, N-(meth)acryloylmorpholine, 2-(meth)acryloyloxyethylsuccinic acid, 2-(meth)acryloyloxyethylphthalic acid, 2-(meth)acryloyloxyethyl acid phosphate, N-vinylpyrrolidone and N-vinylcaprolactam; and compounds having two or more ethylenically unsaturated groups in one molecule such as ethylene glycol di(meth)acrylate, triethylene glycol di(meth)acrylate, neopentyl glycol di(meth)acrylate, 1,6-hexanediol di(meth)acrylate, trimethylolpropane tri(meth)acrylate, trimethylolethane tri(meth)acrylate, trimethylolpropane-ethyleneoxide additive tri(meth)acrylate, trimethylolpropane-propylene oxide additive tri(meth)acrylate, pentaerythritol di(meth)acrylate, pentaerythritol tri(meth)acrylate, pentaerythritol tetra(meth)acrylate, dipentaerithritol tetra (meth)acrylate, dipentaerythritol penta(meth)acrylate, dipentaerythritol hexa(meth)acrylate, glycerol di (meth) acrylate, and the like. Those ethylenically unsaturated monomers may be used alone or in combination of two or more of those monomers.

In the photosensitive coloring composition of the present invention, the poly thiol (F) as a chain transfer agent may be used as a portion of the photopolymerization initiator. The addition of the poly-thiol prevents the inhibition of polymerization by oxygen and enables uniform photocuring reaction to occur under high light blocking conditions.

The poly thiol compound may be any compound having two or more thiol groups. Examples of the poly thiol compound include hexanedithiol, decanedithiol, 1,4-butanediolbisthiopropionate, 1,4-butanediol bisthioglycolate, ethylene glycol bisthioglycolate, ethylene glycol bisthiopropionate, trimethylolpropane tristhioglycolate, trimethylolpropane tristhiopropionate, pentaerythritol tetrakisthioglycolate, pentaerythritol tetrakisthiopropionate, trimercaptopropionic acid tris (2-hydroxyethyl) isocyanurate, 1,4-dimethylmercapto-benzene, 2,4,6-trimercapto-s-triazine, 2-(N,N-dibutylamino)-4,6-dimercapto-s-triazine, and the like. Those poly thiol compounds can be used alone or in combination of two or more those compounds.

The blending ratios of the poly thiol to the photopolymerization initiator selected from the hexaarylbiimidazole compound (i), the triazine compound (ii), the aminoacetophenone compound (iii), the combination of the sensitizer and the organoboron salt compound (iv), the titanocene compound (v), and the oxadiazole compound (vi) is preferably from 10:1 to 1:10. Blending ratios outside this range can provide insufficient photosensitivity. A more preferred range of the blending ratio is from 5:1 to 1:5.

Other photo-polymerization initiator other than those described above can be optionally added in the photosensitive coloring composition according to the present invention. Such photo-polymerization initiators include acetophenone-based compounds such as diethoxyacetophenone, 2-hydroxy-2-methyl-1-phenylpropane-1-one, 1-(4-isopropylphenyl)-2-hydroxy-2-methylpropane-1-one, 1-hydroxycyclohexyl phenyl ketone and 4-tert-butyl-trichloroacetophenone; benzoin-based compounds such as benzyl dimethyl ketal, benzoin ethyl ethel and benzoin isopropyl ether; glyoxyester-based compounds such as methylphenylglyoxylate; acylphosphine oxide-based compounds such as 2,4,6-trimethylbenzoyldiphenyl phosphine oxide; and bisacylphosphine oxide-based compounds such as bis(2,6-dimethoxybenzoyl)-2,4,4-trimethylpentyl phosphine oxide, bis(2,6-dichlorbenzoyl)-phenyl phosphine oxide, bis(2,6-dichlorbenzoyl)-2,5-dimethylphenyl phosphine oxide and bis(2,4,6-trimethylbenzoyl)phenyl phosphine oxide, and the like.

Moreover, a hydrogen-donor compound can be added in the photosensitive coloring composition according to the present invention. The hydrogen-donor compound is a compound which can supply hydrogen to an initiator excited by light and a radical generated from the initiator. Examples thereof include aliphatic amines such as triethanolamine and methyl-diethanolamine; aromatic amines such as 2-dimethyl-aminoethylbenzoic acid, ethyl 4-dimethylaminobenzoate, isobutyl 4-dimethylaminobenzoate and 4,4′-bis(dimethylamino)benzo-phenone; and thiol compounds such as 2-mercaptobenzothiazole, 2-mercaptobenzoimidazole and 2-mercaptobenzoxazole.

In the photosensitive coloring composition of the present invention, the components other than the organic solvent (C) have preferred contents as described below assuming that the sum of the components other than the organic solvent is 100 mass %.

The binder resin (A) having an amido group and a carboxyl group or the mixed binder resin consisting of the binder resin (A) and the epoxy(meth)acrylate resin (A′), has a content of preferably from 10 to 40 mass % and more preferably from 15 to 35 mass %. If the content is 10 mass % or less, the film strength will be decreased and the content above 40 mass % will give rise to insufficient optical density.

In particular, in a case where the component (A′) is used in combination, the component (A) has a content of preferably 8 to 30 mass % and more preferably from 10 to 25 mass %. If the content is below 8 mass %, the film strength will be decreased while the content above 30 mass % will result in an insufficient optically opaque property. The component (A′) has a content of preferably 8 to 30 mass % and more preferably from 10 to 25 mass %. If the content is below 8 mass %, the photosensitivity will be decreased while the content above 30 mass % will result in a decrease in the optically opaque property.

The content of the coloring material (B) is preferably from 25 to 60 mass % and more preferably from 35 to 55 mass %. The content of less than 25 mass % will result in an insufficient optically opaque property while the content above 60 mass % will result in a decrease in film strength.

The content of the photopolymerization initiator (D) is preferably from 2 to 25 mass %, and more preferably from 5 to 20 mass %. If the content is below 2 mass %, the sufficient photosensitivity can not be obtained while the content above 25 mass % will result in too high photosensitivity that the resolution will be decreased.

In a case where the ethylenically unsaturated monomer (E) is blended, its content is preferably 5 to 20 mass % and more preferably from 8 to 18 mass %. The content of below 5 mass % will result in insufficient photosensitivity while the content above 20 mass % will result in insufficient optical density.

Further, in a case where the poly thiol (F) is added, the photopolymerization initiator (D) is in a content of preferably from 2 to 20 mass % and more preferably from 3 to 15 mass %. The content below 2 mass % will result in an insufficient photosensitivity while the content above 20 mass % will result in such a high photosensitivity that the resolution will conversely be decreased. On this occasion, a preferred blending amount of the poly thiol (F) is from 2 to 20 mass % and more preferably from 3 to 15 mass %. The content below 2 mass % will fail to give rise to the effect of poly thiol while the content above 20 mass % will result in such a high photosensitivity that the resolution will conversely be decreased:

(III) Production Method for Coloring Composition and Photosensitive Coloring Composition

The coloring composition of the present invention is used in a state where the binder resin (A) having an amido group and a carboxyl group and the coloring material (B) and optionally the epoxy (meth) acrylate resin (A′) are dissolved or dispersed in the organic solvent (C). In the photosensitive coloring composition of the present invention, further the photopolymerization initiator (D), and optionally the ethylenically unsaturated monomer (E) and the poly thiol (F) may be similarly dissolved therein.

The organic solvents (C) are not particularly limited, and there are exemplified ethers such as diisopropyl ether, ethyl isobutyl ether and butyl ether; esters such as ethyl acetate, isopropyl acetate, butyl(n, sec, tert) acetate, amyl acetate, ethyl 3-ethoxypropionate, methyl 3-methoxypropionate, ethyl 3-methoxypropionate, propyl 3-methoxypropionate and butyl 3-methoxypropionate; ketones such as methyl ethyl ketone, isobutyl ketone, diisopropyl ketone, ethyl amyl ketone, methyl butyl ketone-, methyl hexyl ketone, methyl isoamyl ketone, methyl isobutyl ketone and cyclohexanone; and glycols such as ethylene glycol monomethyl ether, ethylene glycol monoethyl ether, ethylene glycol diethyl ether, ethylene glycol monomethyl ether acetate, ethylene glycol monoethyl ether acetate, diethylene glycol monoethyl ether acetate, propylene glycol mono-t-butyl ether, propylene glycol monomethyl ether, propylene glycol monoethyl ether, propylene glycol monomethyl ether acetate, propylene glycol monoethyl ether acetate, dipropylene glycol monoethyl ether, dipropylene glycol monomethyl ether, dipropylene glycol monomethyl ether acetate, dipropylene glycol monoethyl ether acetate, ethylene glycol monobutyl ether and tripropylene glycol methyl ether, and the like.

The organic solvent is preferably selected from solvents that can dissolve or disperse the respective components and have a boiling point in a range from 100 to 200° C. and more preferably 120 to 170° C. These solvents may be used singly or two or more of them in mixture. It is desirable that the composition of the present invention be prepared so that it has a solids content in a range of from 5 to 50 mass %,preferably from 10 to 30 mass %.

In a case where the modified carbon black is used as the coloring material (B), the modified carbon black treated and adjusted by the method as described above, which is obtained as a dispersion, may be blended as it is with the other components to form a coloring composition or a photosensitive coloring composition.

In the present invention, one or two or more substances selected from each of the components may be used as the each component.

In the present invention, besides the essential components, pigment dispersants, adhesion improvers, leveling agents, development improvers, antioxidants, thermal polymerization inhibitors and the like may be suitably added.

In particular, in the coloring composition of the present invention, it is important to finely disperse the coloring material and stabilize the state of dispersion in order to obtain a stabilized quality so that in some cases it is desirable to blend a pigment dispersant therein. The pigment dispersant has affinity for both the pigment and binder resin and includes surfactants such as nonions, cations and anions, polymer dispersants and the like. Among them, the polymer dispersants are preferred. In particular, polymer dispersants having basic functional groups such as primary, secondary, or tertiary amino groups, and nitrogen-containing heterocycles, for example, pyridine, pyrimidine, and pyrazine and functional groups such as an amido group and an urethane group can be advantageously used.

Next, the method of producing the coloring composition of the present invention will be described. In the present invention, it is preferred that the coloring material is preliminarily dispersed by using a paint conditioner, a sand grinder, a ball mill, a three-roll mill, a stone mill, a jet mill, a homogenizer or the like. The dispersion treatment makes the coloring material to form fine particles 60 that improvement of light blocking ability and improvement of coating property can be achieved in the case of resists for black matrices and sharp color properties and improvement of coatability can be achieved in the case of RGB resists.

In the dispersion treatment, it is preferred that the treatment is performed in a system containing a combination of the coloring material (B), solvent (C) and pigment dispersant, and the component (A) or a combination of the component (A) and component (A′). In particular, use of the polymer dispersant is preferred since it can provide excellent dispersion stability with a lapse of time.

In a case where the dispersion is performed by using a sand grinder, glass beads or zirconia beads having a diameter of from 0.1 to several millimeters may be advantageously used. The condition of dispersion is usually a temperature in a range of from 0 to 100° C., preferably in a range of from room temperature to 80° C. The time of dispersion may be adjusted as appropriate since it may vary depending on the composition of the coloring composition (coloring material, solvent, dispersant, and binder resin) and the device size of the sand grinder and the like.

In a case where a three-roll mill is used for the dispersion, the dispersion is performed at a temperature in a range of from 0 to 60° C. and in case the frictional heat is much to elevate the temperature to above 60° C., the inside of the roll is cooled by circulating water. The number of passing the coloring composition through the three-roll mill depends on the linear speed of the roll, the pressure between the rolls, the viscosity of the material and the like conditions so that it is not generally defined. However, it is usually in a range of from 2 to 10 times.

To produce the photosensitive coloring composition of the present invention, the coloring composition obtained by the dispersion treatment described above and the above-mentioned components necessary as the other components of the photosensitive coloring composition are added and mixed to form a uniform solution. In a case where a modified carbon black is used as the coloring material, the dispersion treatment has already been performed during its production process and the carbon black particles therein have been made into fine particles so that the photosensitive coloring composition can be readily produced by mixing with other components and stirring the mixture to dissolve them. In the production process, it is often the case that fine dust may be mixed into the photosensitive solution, so that it is desirable that the photosensitive coloring composition thus obtained is subjected to filtration treatment by using a filter or the like.

Although it may be good enough that finally the necessary formulation is obtained as the photosensitive cloring composition but the dispersion treatment of the liquid in which all the components are mixed has the possibility of denaturation of highly reactive components due to the heat generated during the dispersion and hence it is desirable that the coloring composition be prepared first as described above and then the other necessary components be mixed therewith.

(IV) Color Filter and Production Method Therefor

Subsequently, the production method for a color filter using the photosensitive coloring composition of the present invention will be described.

First, an example of a color filter for a liquid crystal display device having laminated a resin black matrix, pixels, and a protective layer in the order cited will be described.

A black photosensitive coloring composition is coated on a transparent substrate. Then, after drying the solvent in an oven or the like, the composition is imagewise exposed and developed to form a black matrix pattern, followed by post-baking to complete a back matrix.

Herein the transparent substrate is not particularly limited and inorganic glasses such as silica glass, borosilicate glass, and lime soda glass coated with silica on the surface thereof, films or sheets of polyesters such as polyethylene terephthalates, polyolefins such as polypropylenes and polyethylenes, thermoplastics such as polycarbonates, polymethyl methacrylates, and polysulfones, thermosetting plastics such as epoxy resins, polyester resins and the like may be preferably used. Such transparent substrates as described above may be subjected in advance to various treatments for improving the physical properties thereof such as adhesion of the surface, for example, a corona discharge treatment, an ozone treatment, forming a thin film of a silane coupling agent or various polymers such as a urethane polymer.

As the coating method, coating with a dip coater, coating with a roll coater, coating with a wire bar, coating with a flow coater, coating with a die coater, and spraying as well as a rotating coating method by using a spinner may be suitably used.

The solvent is dried by using a drying apparatus such as a hot plate, an IR oven, a convection oven or the like. A preferred drying condition is at 40 to 150° C. for a drying time in a range of 10 seconds to 60 minutes. The solvent may also be dried off under vacuum.

The method of exposure is performed imagewise by placing a photo mask on the specimen and imagewise exposing through the photo mask. The light source that is used for exposure to light includes, for example, lamp light sources such as a xenon lamp, a high pressure mercury lamp, a super-high pressure mercury lamp, a metal halide lamp, a medium pressure mercury lamp, and a low pressure mercury lamp, laser light sources such as argon ion laser, YAG laser, excimer laser, and nitrogen laser and the like. In a case where an emission light having a specified wavelength alone is to be used, an optical filter may be used.

The black photosensitive coloring composition of the present invention has high sensitivity even at high optical density and can be cured by irradiation of optical energy of 100 mJ/cm² or less. Here, the energy amount of light irradiation can be measured by using, for example, an ultraviolet ray integrating photometer UIT-150 (light receiving part: UVD-S365), manufactured by Ushio Inc.

The development treatment is performed with a developer by a dipping method, a showering method or a paddle method to effect development of the resist. The developer is not particularly limited as far as it has the ability of dissolving the resist membrane in a non-exposed region. For example, organic solvents such as acetone, methylene chloride, triclene, and cyclohexanone may be used. However, since many organic solvents may cause environmental pollution, have toxicity to humans and the possibility of starting a fire, it is preferred that alkali developers having no such possibility be used. Examples of such a preferred alkali developer include aqueous solutions containing inorganic alkali agents such as sodium carbonate, potassium carbonate, sodium silicate, potassium silicate, sodium hydroxide, and potassium hydroxide, or organic alkali agents such as diethanolamine, triethanolamine, and tetraalkylammonium hydroxide salts. The alkali developer may contain surfactants, water-soluble organic solvents, low molecular weight compounds having a hydroxyl-group or a carboxyl group and the like. In particular, most surfactants have improving effects on developability, resolution and background stain and the like so that it is preferred to add them to the composition.

For example, the surfactant for the developer includes anionic surfactants having a sodium naphthalene sulfonate group or a sodium benzenesulfonate group, nonionic surfactants having a polyalkyleneoxy group, cationic surfactants having a tetraalkylammonium group and the like. The method of developing treatment is not particularly limited but usually it is performed at a developing temperature of from 10 to 50° C., preferably from 15 to 45° C., by a method utilizing a dipping development, a spraying development, a brush development, ultrasonic development or the like.

The post-baking is performed at a temperature in a range of from 150 to 300° C. for a time in a range of from 1 to 120 minutes by using a similar apparatus used in the drying of the solvent.

The black matrix thus obtained has a film thickness in a range of from 0.1 to 2 μm, preferably from 0.1 to 1.5 μm, and more preferably from 0.1 to 1.0 μm. In addition, in order to exhibit the function of the black matrix, it is preferred that the black matrix has an optical density of 3 or more at that film thickness.

The black matrix pattern fabricated in this process has opening portions having a size on the order of from 20 to 200 μm between the black matrixes. In a later step, R (red), G (green) and B (blue) pixels are formed in the spaces.

Next, a plurality of colors pixels are formed in the opening portions of the black matrix. Usually, the colors of the pixels are three, i.e., RGB and the photosensitive composition is colored with the pigments or dyes described above. First, the photosensitive coloring composition is coated on a transparent substrate on which the black matrix pattern is mounted. Next, the solvent is dried by using an oven or the like to form a first colored layer on all over the surface of the black matrix. Usually, a color filter has respective pixels of a plurality of colors, so that unnecessary portion is removed by a photolithographic method to form a desired pixel pattern of the first color. The pixel has a film thickness on the order of from 0.5 to 3 μm. This procedure is repeated for a number of times corresponding to the number of necessary colors of pixels to form pixels of a plurality of colors, followed by producing a color filter. It is preferred that the apparatus and chemicals used in the process of forming each pixel are the same but different apparatus and chemicals may be used without problems.

Thereafter, a protective layer may be laminated on the pixels of a plurality of colors, as necessary. The protective layer may be made of an acrylic resin, an epoxy resin, a silicone resin, a polyimide resin or the like and is not particularly limited.

In addition to the above, there maybe mentioned a so-called rear side exposing method, that is, a method in which after forming patterned pixels on a transparent substrate in advance, the black photosensitive coloring composition is coated and light is exposed on the side of the transparent substrate to form a black matrix between the pixels using the pixels as masks.

Finally, the lamination of an ITO transparent electrode and patterning it may be performed by a conventional method, as necessary.

The use of the coloring composition or photosensitive coloring composition of the present invention can form a resin black matrix having low reflectivity in which a film thickness, content of black pigment, strength of resin and the like are practically usable.

### INDUSTRIAL APPLICABILITY

By using the resin (A) having an amido group and a carboxyl group as the binder resin, and preferably an acrylic copolymer such as N-(meth)acryloylmorpholine, N-vinylpyrolidone or N-vinylcaprolactam as the monomer for introducing an amido group, the dispersibility of the color material, in particular the black pigment such as the carbon black, as the coloring material upon producing the coloring composition can be improved. That is, the use of such an acrylic copolymer can reduce the amount of the dispersant to a half that of the conventional binder resin generally used heretofore.

The use of a combined binder resin consisting of the resin (A) having an amido group and a carboxyl group and the epoxy(meth)acrylate resin (A′), preferably novolak epoxy(meth)acrylate resin having a carboxyl group, particularly preferably cresol novolak epoxy(meth)acrylate resin having a carboxyl group, as the binder resin can improve the photosensitivity of the photosensitive coloring composition for color filters of the present invention, in particular the photosensitive coloring composition for color filters containing a black pigment such as the carbon black as the coloring material. The photosensitivity of the photosensitive coloring composition using the combined binder resin can be increased to from several times to several tens times-as that of the composition in which no such epoxy(meth)acrylate resin is used in combination and the resin-(A) is used alone.

The use of the novolak epoxy(meth)acrylate resin having a phenyl nucleus number in a range of from 4 to 7 can drastically improve the compatibility with the resin (A) having a carboxyl group, resulting in that a black matrix having low reflectivity can be formed. Therefore, the photosensitive coloring composition for color filters of the present invention can be used most suitably for color filter resists in particular for black matrices.

The modified carbon black treated with the compound having an isocyanate group and an ethylenically unsaturated bond in the molecule is excellent in dispersibility and in addition has an ethylenically unsaturated group so that the use of the modified carbon black as the coloring material can give rise to a photosensitive coloring composition excellent in optically opaque property, photosensitivity and dispersion stability. Therefore, the photosensitive black resin composition using the modified carbon black can be suitably used for a black matrix for color filters that require high optical density, high precision and low reflectivity.

The photosensitive black resin composition has very high dispersion stability of the modified carbon black and considerably improves photosensitivity so that it can be used as a black UV curing coating composition as well.

### BEST MODE FOR CARRYING OUT THE INVENTION

Hereinafter, the present invention will be described by examples. However, the present invention should by no means be limited to these examples.

### SYNTHESIS EXAMPLE 1

### Synthesis of Acrylic Copolymer (AP-1)

In a four-necked flask equipped with a dropping funnel, a thermometer, a condenser and a stirrer were charged 12.0 mass parts of methacrylic acid (MA), 13.5 mass parts of methyl methacrylate (MMA), 42.0 mass parts of n-butyl methacrylate (BMA), 7.5 mass parts of N-acryloylmorpholine (ACMO), and 225.0 mass parts of propylene glycol monomethyl ether acetate (PMA) and the inside of the flask was purged with nitrogen for 1 hour. Further, after elevating the temperature up to 90° C. on an oil bath, a mixed solution of 12.0 mass parts of MA, 13.5 mass parts of MMA, 42.0 mass parts of BMA, 7.5 mass parts of ACMO, 225.0 mass parts of PMA and 3.2 mass parts of 2,2′-azobisisobutyronitrile (AIBN) was dripped over 1 hour. After 3 hours' polymerization, a mixed solution of 1.0 mass part of AIBN and 15.0 mass parts of PMA was added and the temperature was elevated up to 100° C. and the polymerization was performed for 1.5 hours and then the reaction mixture was left to cool. The acrylic copolymer thus obtained was named AP-1. AP-1 had a solids content of 23.3% and acid value of 93 mgKOH/g and a weight average molecular weight of 25, 000 in terms of polystyrene as measured by GPC.

### SYNTHESIS EXAMPLE 2

### Synthesis of Acrylic Copolymer (AP-2)

In a four-necked flask equipped with a dropping funnel, a thermometer, a condenser and a stirrer were charged 12.0 mass parts of MA, 14.0 mass parts of MMA, 43.0 mass parts of BMA, 6.0 mass parts of N-vinylcaprolactam (VC), and 225.0 mass parts of PMA and the inside of the flask was purged with nitrogen for 1 hour. Further, after elevating the temperature up to 90° C. on an oil bath, a mixed solution of 12.0 mass parts of MA, 14.0 mass parts of MMA, 43.0 mass parts of BMA, 6.0 mass parts of VC, 225.0 mass parts of PMA and 3.2 mass parts of AIBN was dripped over 1 hour. After 3 hours' polymerization, amixed solution of 1.0 mass part of AIBN and 15.0 mass parts of PMA was added and the temperature was elevated up to 100° C. and the polymerization was performed for 1.5 hours and then the reaction mixture was left to cool. The acrylic copolymer thus obtained was named AP-2. AP-2 had a solids content of 22.5% and acid value of 92 mgKOH/g and a weight average molecular weight of 22,000 in terms of polystyrene as measured by GPC.

### SYNTHESIS EXAMPLE 3

### Synthesis of Acrylic Copolymer (Comparative P-1)

In a four-necked flask equipped with a dropping funnel, a thermometer, a condenser and a stirrer were charged 12.0 mass parts of MA, 14.0 mass parts of MMA, 43.0 mass parts of BMA, 6.0 mass parts of 2-hydroxyethylactrylate (HEMA), and 225.0 mass parts of PMA and the inside of the flask was purged with nitrogen for 1 hour. Further, after elevating the temperature up to 90° C. on an oil bath, a mixed solution of 12.0 mass parts of MA, 14.0 mass parts of MMA, 43.0 mass parts of BMA, 6.0 mass parts of HEMA, 225.0 mass parts of PMA and 3.2 mass parts of AIBN was dripped over 1 hour. After 3 hours' polymerization, amixed solution of 1.0 mass part of AIBN and 15.0 mass parts of PMA was added and the temperature was elevated up to 100° C. and the polymerization was performed for 1.5 hours and then the reaction mixture was left to cool. The acrylic copolymer thus obtained was named Comparative AP-1. Comparative AP-1 had a solids content of 22.1% and acid value of 92 mgKOH/g and a weight average molecular weight of 23,000 in terms of polystyrene as measured by GPC.

### SYNTHETIC EXAMPLE 4

### Synthesis of Epoxyacrylate Resin (EP-1)

In a flask were charged 210 mass parts of a cresol novolak epoxy resin (EPOTOHTO YDCN-704, manufactured by Tohto Kasei Co., Ltd., epoxy equivalent 210; softening point 90° C.), 72 mass parts of an acrylic acid, 0.28 mass part of hydroquinone, 232.6 mass parts of diethylene glycol monoethyl ether acetate and the mixture was heated to 95° C. After confirming that the mixture was dissolved uniformly, 1.4 mass parts of triphenylphosphine was charged and the resulting mixture was heated to 100° C. and then allowed to react for about 30 hours to obtain a reaction mixture having an acid value of 0.5 mgKOH/g. To this was charged 66.9 mass parts of tetrahydrophthalic anhydride and the mixture was heated to 90° C. and allowed to react for about 6 hours. The disappearance of absorption of the acid anhydride was confirmed by IR analysis to obtain epoxyacrylate resin EP-1 having a solids acid value of 70 mgKOH/g and a solids content of 60.0%.

### SYNTHETIC EXAMPLE 5

### Synthesis of Epoxyacrylate Resin (EP-2)

In a flask were charged 210 mass parts of a cresol novolak epoxy resin (EPOTOHTO YDCN-704, manufactured by Tohto Kasei Co., Ltd., epoxy equivalent 210; softening point 90° C.), 72 mass parts of an acrylic acid, 0.28 mass part of hydroquinone, 232.6 mass parts of diethylene glycol monomethyl ether acetate and the mixture was heated to 95° C. After confirming that the mixture was dissolved uniformly, 1.4 mass parts of triphenylphosphine was charged and the resulting mixture was heated to 100° C. and then allowed to react for about 30 hours to obtain a reaction mixture having an acid value of 0.5 mgKOH/g. To this was charged 44 mass parts of succinic anhydride and the mixture was heated to 90° C. and allowed to react for about 6 hours. The disappearance of absorption of the acid anhydride was confirmed by IR analysis to obtain epoxyacrylate resin EP-2 having a solids acid value of 70 mgKOH/g and a solids content of 58.5%.

### EXAMPLE 1

### Preparation of Coloring Composition-1

After mixing 30.0 mass parts of AP-1 (solids content 7.0 mass parts), 5.0 mass parts of PMA, 3.5 mass parts of FLOWLEN DOPA-33 (manufactured by Kyoeisha Chemical Co., Ltd., dispersant, solids content 30%) and 7.0 mass parts of special Black 4 (carbon black available from Degussa AG) was left to stand overnight. After stirring for additional 1 hour, the mixture was passed 4 times through a three-roll mill (Model RIII-1RM-2, manufactured by Kodaira Seisakusho Co., Ltd.). To the black ink thus obtained was added cyclohexanone to adjust concentration to obtain Black Color Composition-1 having a solids content of 18.0%.

### EXAMPLES 2 TO 9

### Preparation of Coloring Compositions-2 to −9

Black, blue and red coloring compositions were prepared in the same method as in Example 1 by using the formulations shown in Table 2 to obtain Coloring Compositons-2 to −9, respectively.

### COMPARATIVE EXAMPLES 1 TO 3

### Preparation of Comparative Coloring Compositions-1 to -3

Black coloring compositions were prepared in the same method as in Example 1 by using the formulations shown in Table 2 to obtain Comparative Coloring Compositons-1 to −3, respectively.

[Evaluation of Pigment-Dispersibility]

The pigment dispersibility of the obtained colored pastes was evaluated by observing their filterability when using a filter having a pore size of 0.8 μm (for GFP, Kiriyama Filter Paper). When the dispersibility of the pigment was good, the sample was judged to be good (Judgment:O). On the other hand, when the dispersibility of the pigment was bad, agglomeration of the pigment particles occurred and the filter was clogged so that no filtration was realized (Judgment:X).

By this method, evaluation of Examples 1 to 9 and Comparative Examples 1 to 3 was performed. Table 2 shows the results obtained.

The coloring compositions using the binder resins AP-1 and AP-2 of the present invention had good filterability although they had low concentrations of the dispersant (Coloring Composition-2 and Coloring Composition-4). On the contrary, the coloring composition using Comparative AP-1 caused clogging at low concentrations of the dispersant and no filtration could be realized (Comparative Coloring Composition-3) Examples 10 to 19 and Comparative Examples 4 and 5: Preparation of photosensitive coloring compositions for color filters (for black matrix resists).

TABLE 2

| | | | |
|---|---|---|---|
| | | | Compounding |
| | | Compounding | Amount of |
| | | Amount | Solids |
| Component | Kind | (part by mass) | (part by mass) |

Example 1: Coloring Composition -1

| | | | |
|---|---|---|---|
| (A) | AP-1 | 30.0 | 7.0 |
| (A′) | — | — | — |
| Dispersant | DOPA-33 | 3.6 | 1.1 |
| (B) | SB-4 | 7.0 | 7.0 |
| (C) | PMA | 5.0 | — |

| | |
|---|---|
| Pigment | O |
| Dispersibility | |

Example 2: Coloring Composition -2

| | | | |
|---|---|---|---|
| (A) | AP-1 | 30.0 | 7.0 |
| (A′) | — | — | — |
| Dispersant | DOPA-33 | 1.4 | 0.4 |
| (B) | SB-4 | 7.0 | 7.0 |
| (C) | PMA | 5.0 | — |

| | |
|---|---|
| Pigment | O |
| Dispersibility | |

Example 3: Coloring Composition -3

| | | | |
|---|---|---|---|
| (A) | AP-2 | 30.0 | 6.8 |
| (A′) | — | — | — |
| Dispersant | DOPA-33 | 3.4 | 1.0 |
| (B) | SB-4 | 6.8 | 6.8 |
| (C) | PMA | 5.0 | — |

| | |
|---|---|
| Pigment | O |
| Dispersibility | |

Example 4: Coloring Composition -4

| | | | |
|---|---|---|---|
| (A) | AP-2 | 30.0 | 6.8 |
| (A′) | — | — | — |
| Dispersant | DOPA-33 | 1.4 | 0.4 |
| (B) | SB-4 | 6.8 | 6.8 |
| (C) | PMA | 5.0 | — |

| | |
|---|---|
| Pigment | O |
| Dispersibility | |

Example 5: Coloring Composition -5

| | | | |
|---|---|---|---|
| (A) | AP-1 | 30.0 | 7.0 |
| (A′) | — | — | — |
| Dispersant | DOPA-33 | 4.2 | 1.3 |
| (B) | SB-4 | 10.5 | 10.5 |
| (C) | PMA | 10.0 | — |

| | |
|---|---|
| Pigment | O |
| Dispersibility | |

Example 6: Coloring Composition -6

| | | | |
|---|---|---|---|
| (A) | AP-1 | 20.0 | 4.7 |
| (A′) | EP-1 | 4.2 | 2.5 |
| Dispersant | DOPA-33 | 4.3 | 1.3 |
| (B) | SB-4 | 10.8 | 10.8 |
| (C) | PMA | 10.0 | — |

| | |
|---|---|
| Pigment | O |
| Dispersibility | |

Example 7: Coloring Composition -7

| | | | |
|---|---|---|---|
| (A) | AP-1 | 13.0 | 3.0 |
| (A′) | EP-2 | 2.8 | 1.6 |
| Dispersant | DOPA-33 | 3.9 | 1.2 |
| (B) | SB-4 | 11.7 | 11.7 |
| (C) | PMA | 14.0 | — |

| | |
|---|---|
| Pigment | O |
| Dispersibility | |

Example 8: Coloring Composition -8

| | | | |
|---|---|---|---|
| (A) | AP-1 | 30.0 | 7.0 |
| (A′) | — | — | — |
| Dispersant | DOPA-33 | 4.2 | 1.3 |
| (B) | CB4930PK | 10.5 | 10.5 |
| (C) | PMA | 9.0 | — |

| | |
|---|---|
| Pigment | O |
| Dispersibility | |

Example 9: Coloring Composition -9

| | | | |
|---|---|---|---|
| (A) | AP-1 | 30.0 | 7.0 |
| (A′) | — | — | — |
| Dispersant | DOPA-33 | 4.3 | 1.3 |
| (B) | E5B02 | 10.5 | 10.5 |
| (C) | PMA | 9.0 | 9.0 |

| | |
|---|---|
| Pigment | O |
| Dispersibility | |

Comparative example 1: Comparative
Coloring Composition -1

| | | | |
|---|---|---|---|
| (A) | Comparative | 30.0 | 6.6 |
| | AP-1 | | |
| (A′) | — | — | — |
| Dispersant | DOPA-33 | 3.3 | 1.0 |
| (B) | SB-4 | 6.6 | 6.6 |
| (C) | PMA | 5.0 | 5.0 |

| | |
|---|---|
| Pigment | O |
| Dispersibility | |

Comparative Example 2: Comparative
Coloring Composition -2

| | | | |
|---|---|---|---|
| (A) | — | — | — |
| (A′) | EP-1 | 10.0 | 5.9 |
| Dispersant | DOPA-33 | 3.0 | 0.9 |
| (B) | SB-4 | 5.9 | 5.9 |
| (C) | PMA | 15.0 | — |

| | |
|---|---|
| Pigment | O |
| Dispersibility | |

Comparative example 3: Comparative
Coloring Composition -3

| | | | |
|---|---|---|---|
| (A) | Comparative | 30.0 | 6.6 |
| | AP-1 | | |
| (A′) | — | — | — |
| Dispersant | DOPA-33 | 1.3 | 0.4 |
| (B) | SB-4 | 7.0 | 7.0 |
| (C) | PMA | 5.0 | — |

| | |
|---|---|
| Pigment | X |
| Dispersibility | |

(A): Binder resin having an amido group and a carboxyl group
(A′): Epoxy (meth)acrylate resin
(B): Colorant
(C): Organic solvent
DOPA-33: FLOWLEN DOPA-33 (Solids content 30%), dispersant manufactured by Kyoeisha Chemical Co., Ltd.
SB-4: Special Black 4, carbon black manufactured by Degussa AG (average particle diameter: 25 nm)
PMA: Propylene glycol mono methyl ether acetate
Pigment dispersibility: Coloring paste after dispersing by using a three-roll mill and adjusting to a solids content of 18 mass % with cyclohexanone was filtered through a filter having a pore size of 0.8 μm and the preparation that passed the filter entirely was evaluated as having a pigment dispersibility of 0 and the preparation that did not pass the filter entirely was evaluated as having a pigment dispersibility of X.
CB4930PK: Cyanine Blue 4930PK (Pigment Blue 15:4), phthalocyanine blue pigment, manufactured by Dainichiseika Color & Chemicals Mfg. Co., Ltd.
E5B02: HOSTARM RED E5B02 (Pigment Violet 19), quinacridone red pigment, manufactured by Clariant (Japan) KK.

The photosensitive coloring compositions for color filters having the compositions shown in Table 3 were prepared, and various evaluations thereof were performed after filtration through a filter having a pore size of 0.8 μm (for GFP, Kiriyama Filter Paper).

[Evaluation of Photosensitivity]

Each of the photosensitive coloring compositions of Examples 10 to 19 and Comparative Examples 4 and 5 shown in Table 3 was spin-coated on a glass substrate (size: 100×100 mm) and dried at room temperature for 30 minutes and then pre-baked at 70° C. for 20 minutes. After measuring the film thickness of the formed resist by using a film thickness meter (SURFCOM 130A, trade name; manufactured by Tokyo Seimitsu Co., Ltd.), the resist was photocured in an exposing apparatus having incorporated an ultrahigh pressure mercury lamp (trade name: MultilightML-251A/B, manufactured by Ushio Inc.) at varied exposure amounts. The exposure amount was measured by an ultraviolet integrating photometer (tradename: UIT-150 (light receivingpart: UVD-S365), manufactured by Ushio Inc.). Further, the resist was subjected to alkali development with 0.1% aqueous solution (25° C.) of Developer 9033 (manufactured byShipley Far East Ltd.), which was an alkali developer containing potassium carbonate (the developing time being set to twice the time required for complete development of the resist film before exposure to light by the alkali development). After completion of the alkali development, the glass substrate was washed with water, dried by air spraying and the film thickness of the remaining resist was measured. The photosensitivity of the photosensitive coloring composition for color filters was defined as the exposure amount at which the value calculated by the following equation reached 95% or more (remaining film sensitivity). Table 3 shows the results obtained.

$$Remaining Film Sensitivity ( \% ) = 100 \times \frac{( Film thickness after alkali development )}{( Film thickness before alkali development )}$$

Table 3 indicates that the photosensitive coloring compositions for color filters using the acrylic copolymer having an amido group and a carboxyl group (black matrix resist compositions) had high photosensitivity and became very highly sensitive by further blending epoxy acrylate.

[Evaluation of Physical Properties of Resist]

Each of the photosensitive coloring compositions (black matrix resist compositions) for color filters of Examples 10 to 19 and Comparative Examples 4 and 5 shown in Table 3 was spin-coated on a glass substrate (size: 100×100 mm) and dried at room temperature for 30 minutes and then pre-baked at 70° C. for 20 minutes. After photocuring by using an ultrahigh pressure mercury lamp at the exposure amount twice that of the photosensitivity of each composition (resist), the resist was post-baked at 200° C. for 30 minutes and the resist-coated glass substrate thus obtained was used for performing the following evaluations.

(1) OD Values

By measuring transmittance at 550 nm by using a standard plate having a known optical density (OD) value, a calibration curve was prepared. Then, each of the resist-coated glass substrates of Examples and Comparative Examples was measured of transmittance at 550 nm to obtain OD values. Table 3 shows the results obtained.

(2) Reflectivity

By using a spectrophotometer (UV-3100PC, manufactured by Shimadzu Corporation), the reflectivity at 550 nm of each of the resists was measured.

(3) Pencil Scratch Value

By the method prescribed by JIS K5400 “General Test Methods for Coating Composition, 8.4: Pencil Scratch Value,” the strength of coating film of each sample was evaluated. Table 3 shows the results obtained.

Comparative example 5 using only the epoxyacrylate resin was evaluated as 2B and did not have the necessary strength whereas the samples other than that of Comparative Example 5 showed a value of 3H, showing sufficient strength of coating film.

TABLE 3

| | | |
|---|---|---|
| Example 10 | Example 11 | example 12 |

Formulation (part by mass)

| | | | | | | |
|---|---|---|---|---|---|---|
| Coloring composition | Coloring | 100 | Coloring | 100 | Coloring | 80 |
| | Composition -1 | | Composition -3 | | Composition-5 | |
| | | | | | Coloring | 20 |
| | | | | | Composition -8 | |
| (E) Ethylenically | DPHA | 4.4 | DPHA | 4.4 | DPHA | 4.3 |
| unsaturated monomer | | | | | | |
| (D) Photopolymerization | EMK | 0.4 | TAZ | 2.2 | EMK | 0.4 |
| initiator | HABI | 1.2 | | | EAQ | 0.4 |
| | MN3M | 1.3 | | | HABI | 1.8 |
| | | | | | MN3M | 1.3 |
| (F) Poly thiol | TPMP | 1.9 | — | | TPMP | 3.0 |
| (C) Organic solvent | CH | 25.0 | CH | 25.0 | CH | 42.0 |

Results of Evaluation

| | | | |
|---|---|---|---|
| Photosensitivity (mj/cm²) | 100 | 80 | 30 |
| Film thickness after | 1.92 | 1.91 | 1.48 |
| post-baking (μm) | | | |
| OD value (550 nm) | 3.0 | 3.0 | 2.9 |
| Reflectivity (550 nm %) | 2.1 | 2.4 | 1.4 |
| Pencil scratch value | 3 H | 3 H | 3 H |

| | | |
|---|---|---|
| Example 13 | Example 14 | Example 15 |

Formulation (part by mass)

| | | | | | | |
|---|---|---|---|---|---|---|
| Coloring composition | Coloring | 80 | Coloring | 100 | Coloring | 100 |
| | Composition -5 | | Composition -6 | | Composition -6 | |
| | Coloring | 20 | | | | |
| | Composition -9 | | | | | |
| (E) Ethylenically | DPHA | 4.3 | DPHA | 4.4 | DPHA | 4.4 |
| unsaturated monomer | | | | | | |
| (D) Photopolymerization | EMK | 0.4 | EMK | 0.4 | | |
| initiator | EAQ | 0.4 | EAQ | 0.4 | EMK | 0.7 |
| | HABI | 1.8 | HABI | 1.8 | HABI | 2.3 |
| | MN3M | 1.3 | MN3M | 1.3 | | |
| (F) Poly thiol | TPMP | 3.0 | TPMP | 3.0 | TPMP | 3.8 |
| (C) Organic solvent | CH | 42.0 | CH | 42.0 | CH | 42.0 |

Results of Evaluation

| | | | |
|---|---|---|---|
| Photosensitivity (mj/cm²) | 30 | 30 | 10 |
| Film thickness after | 1.56 | 1.21 | 1.46 |
| post-baking (μm) | | | |
| OD value (550 nm) | 3.0 | 3.1 | 3.4 |
| Reflectivity (550 nm %) | 1.6 | 1.8 | 1.4 |
| Pencil scratch value | 3 H | 3 H | 3 H |

| | | |
|---|---|---|
| Example 16 | Example 17 | Example 18 |

Formulation (part by mass)

| | | | | | | |
|---|---|---|---|---|---|---|
| Coloring composition | Coloring | 100 | Coloring | 100 | Coloring | 100 |
| | Composition -6 | | Composition -6 | | Composition -7 | |
| (E) Ethylenically | DPHA | 4.3 | DPHA | 4.4 | DPHA | 4.4 |
| unsaturated monomer | | | | | | |
| (D) Photopolymerization | Irgacure 369 | 3.0 | Irgacure 907 | 2.3 | EMK | 0.7 |
| initiator | | | EMK | 0.7 | HABI | 2.3 |
| (F) Poly thiol | TPMP | 3.8 | TPMP | 3.8 | TPMP | 3.8 |
| (C) Organic solvent | CH | 42.0 | CH | 42.0 | CH | 25.0 |

Results of Evaluation

| | | | |
|---|---|---|---|
| Photosensitivity (mj/cm²) | 20 | 20 | 10 |
| Film thickness after | 1.41 | 1.25 | 1.05 |
| post-baking (μm) | | | |
| OD value (550 nm) | 3.2 | 3.0 | 3.2 |
| Reflectivity (550 nm %) | 1.2 | 1.3 | 2.0 |
| Pencil scratch value | 3 H | 3 H | 3 H |

| | | |
|---|---|---|
| | Comparative | Comparative |
| Example 19 | example 4 | example 5 |

Formulation (part by mass)

| | | | | | | |
|---|---|---|---|---|---|---|
| Coloring composition | Coloring | 100 | Comparative | 100 | Comparative | 100 |
| | Composition -7 | | Coloring | | Coloring | |
| | | | Composition -1 | | Composition -2 | |
| (E) Ethylenically | DPHA | 4.4 | DPHA | 4.4 | DPHA | 4.4 |
| unsaturated monomer | | | | | | |
| (D) Photopolymerization | EMK | 0.3 | EMK | 0.4 | EMK | 0.4 |
| initiator | EAQ | 0.3 | | | | |
| | Cation Dyestuff | 0.3 | HABI | 1.2 | HAB | 1.2 |
| | N3B | 1.5 | MN3M | 1.3 | MN3M | 1.3 |
| (F) Poly thiol | TPMP | 3.0 | TPMP | 1.9 | TPMP | 1.9 |
| (C) Organic solvent | CH | 25.0 | CH | 25.0 | CH | 25.0 |

Results of Evaluation

| | | | |
|---|---|---|---|
| Photosensitivity (mj/cm²) | 30 | 200 | 20 |
| Film thickness after | 1.00 | 1.95 | 1.05 |
| post-baking (μm) | | | |
| OD value (550 nm) | 3.1 | 3.0 | 2.0 |
| Reflectivity (550 nm %) | 2.4 | 1.9 | 1.6 |
| Pencil scratch value | 3 H | 3 H | 2 B |

DPHA: Dipentaerythritol hexaacrylate
EMK: 4,4′-Bis(N,N-diethylamino)benzophenone
HABI: 2,2′-Bis(o-chlorophenyl)-4,4′,5,5′-tetraphenyl-1,2′-biimidazole
MN3M: Tetra-n-butylammonium methyltris[1-(4-methylnaphthyl)]borate
TPMP: Trimethylolpropane tristhiopropionate
CH: Cyclohexanone
TAZ: 2-(4-Methoxystyryl)-4,6-bis(trichloromethyl)-s-triazine
EAQ: 2-Ethylanthraquinone
Irgacure 369: 2-Benzyl-2-dimethylamino-1-(4-morpholinophenyl)butanone-1 (Ciba Specialty Chemicals K. K.)
Irgacure 907: 2-Methyl-1-[4-(methylthio)phenyl]-2-morpholinopropan-1-on (Ciba Specialty Chemicals K. K.)
Cation Dyestuff: Cation part; Table 1 No. 3, anion part; tetrafluoroborate
N3B: Tetra-n-butylammonium n-butyltri(1-naphthyl)borate

### SYNTHESIS EXAMPLE 6

### Preparation of Carbon Black Dispersion 1

In a stainless can were charged 0.02 mass part of dibutyltin laurate, 100.0 mass parts of propylene glycol monomethyl ether acetate (PMA) dried by using molecular sieves 3A, 10.0 mass parts of Special Black 4 (carbon black, available from Degussa AG), and 1.0 mass part of 2-methacryloyloxyethyl isocyanate (MOI) and further stainless beads of 3 mm in diameter were added thereto, followed by shaking by using a paint conditioner for 3 hours to perform the treatment of carbon black to obtain a dispersion of modified carbon black.

### SYNTHESIS EXAMPLE 7

### Synthesis of Carbon Black Dispersion 2

A dispersion of modified carbon black was obtained in the same method as Synthesis Example 6 except that the carbon black used in Synthesis Example 6 was replaced by 10.0 mass parts of Special Black 350 (available from Degussa AG) and 0.5 mass part of MOI.

### SYNTHESIS EXAMPLE 8

### Synthesis of Carbon Black Dispersion 3

A dispersion of modified carbon black was obtained in the same method as Synthesis Example 6 except that the carbon black used in Synthesis Example 6 was replaced by 10.0 mass parts of Special Black 250 (available from Degussa AG) and 0.5 mass part of MOI.

### SYNTHESIS EXAMPLE 9

### Synthesis of Carbon Black Dispersion 4

A dispersion of modified carbon black was obtained in the same method as Synthesis: Example 6 except that MOI is not used.

### SYNTHESIS EXAMPLE 10

### Synthesis of Carbon Black Dispersion 5

A dispersion of modified carbon black was obtained in the same method as Synthesis Example 7 except that MOI is not used.

[Evaluation of Dispersibility]

0.5 g each of the carbon black dispersions of Synthesis Examples 6 to 10 was charged in a sample vial of 1.5 cm in diameter and 10 cm in height and 10 g of PMA was added thereto followed by well stirring. Thereafter, the mixture was left to stand. After 5 hours, the state of sedimentation of the modified carbon blackandcarbonblackwasobservedbyunaidedeye. Thecasewhere no sedimentation occurred was judged to be good dispersibility and the case where the sedimentation occurred to form a supernatant layer was judged to be bad dispersibility.

Synthesis Examples 6 to 8 showed no sedimentation and had good dispersibility. On the other hand, Synthesis Examples 9 and 10 showed the sedimentation of carbon black so that the dispersibility was bad.

The above results indicate that the modified carbon black treated with the compound having an isocyanate group and an ethylenically unsaturated group in the molecule had good dispersibility.

### SYNTHESIS EXAMPLE 11

### Synthesis of Acrylic Copolymer (AP-3)

In a four-necked flask equipped with a dropping funnel, a thermometer, a condenser and a stirrer were charged 12.0 mass parts of methacrylic acid (MA), 13.0 mass parts of methyl methacrylate (MMA), 39.0 mass parts of n-butyl methacrylate (BMA), 11.0 mass parts of N-acryloylmorpholine (ACMO), and 225.0 mass parts of propylene glycol monomethyl ether acetate (PMA) and the inside of the flask was purged with nitrogen for 1 hour. Further, after elevating the temperature up to 90° C. on an oil bath, a mixed solution of 12.0 mass parts of MA, 13.0 mass parts of MMA, 39.0 mass parts of BMA, 11.0 mass parts of ACMO, 225.0 mass parts of PMA and 3.2 mass parts of 2,2′-azobisisobutyronitrile (AIBN) was dripped over 1 hour. After 3 hours' polymerization, the temperature was elevated up to 100° C. and a mixed solution of 1.0 mass part of AIBN and 15.0 mass parts of PMA was added and the polymerization was performed for 1.5 hours and then the reaction mixture was left to cool. The acrylic copolymer thus obtained was named AP-3. AP-3 had a solids content of 23.3% and acid value of 94 mgKOH/g and a weight average molecular weight of 26, 000 in terms of polystyrene as measured by GPC.

### SYNTHESIS EXAMPLE 12

### Synthesis of Acrylic Copolymer (AP-4)

In a four-necked flask equipped with a dropping funnel, a thermometer, a condenser and a stirrer were charged 15.0 mass parts of MA, 12.5 mass parts of MMA, 38.0 mass parts of BMA, 9.5 mass parts of ACMO, and 225.0 mass parts of PMA and the inside of the flask was purged with nitrogen for 1 hour. Further, after elevating the temperature up to 90° C. on an oil bath, a mixed solution of 15.0 mass parts of MA, 12.5 mass parts of MMA, 38.0 mass parts of BMA, 9.5 mass parts of ACMO, 225.0 mass parts of PMA and 3.2 mass parts of AIBN was dripped over 1 hour. After 3 hours' polymerization, the temperature was elevated up to 100° C. and a mixed solution of 1.0 mass part of AIBN and 15.0 mass parts of PMA was added and the polymerization was performed for 1.5 hours and then the reaction mixture was left to cool. The acrylic copolymer thus obtained was named AP-4. AP-4 had a solids content of 23.3% and acid value of 117 mgKOH/g and a weight average molecular weight of 25,000 in terms of polystyrene as measured by GPC.

### SYNTHESIS EXAMPLE 13

### Synthesis of Acrylic Copolymer (AP-5)

In a four-necked flask equipped with a dropping funnel, a thermometer, a condenser and a stirrer were charged 12.0 mass parts of MA, 12.0 mass parts of MMA, 37.0 mass parts of BMA, 14.0 mass parts of N-vinylcaprolactam (VC), and 225.0 mass parts of PMA and the inside of the flask was purged with nitrogen for 1 hour. Further, after elevating the temperature up to 90° C. on an oil bath, a mixed solution of 12.0 mass parts of MA, 12.0 mass parts of MMA, 37.0 mass parts of BMA, 14.0 mass parts of VC, 225.0 mass parts of PMA and 3.2 mass parts of AIBN was dripped over 1 hour. After 3 hours' polymerization, the temperature was elevated up to 100° C. and a mixed solution of 1.0 mass part of AIBN and 15.0 mass parts of PMA was added and the polymerization was performed for 1.5 hours and then the reaction mixture was left to cool. The acrylic copolymer thus obtained was named AP-5. AP-5 had a solids content of 23.0% and acid value of 93 mgKOH/g and a weight average molecular weight of 22,000 in terms of polystyrene as measured by GPC.

### EXAMPLES 20 TO 29 AND COMPARATIVE EXAMPLES 6 AND 7

### Preparation of Photosensitive Coloring Compositions

In a stainless can were charged dibutyltin laurate, PMA dried by using molecular sieves 3A, FLOWLEN DOPA-33 (Solids content 30%, dispersant manufactured by Kyoeisha Chemical Co., Ltd.), Special Black 4 (carbon black, available from Degussa AG), andMOIin the formulation shown in Table 4 and well stirred. Then stainless beads of 3 mm in diameter were added thereto, followed by shaking by using a paint conditioner for 3 hours to perform the treatment of carbon black. Thereafter, AP-3 was added and the mixture was further shaken by using a paint conditioner for 1 hour. The resin compositions thus obtained were filtered through a filter having a pore size of 0.8 μm (for GFP, Kiriyama Filter Paper) to remove dust or large particles of carbon black. The resin compositions: thus obtained were named Coloring Compositions-10 to −14 and Comparative Coloring Composition-2.

Each of Coloring Compositions-10 to −14 and Comparative Coloring Composition-2, photopolymerization initiator, ethylenically unsaturated compound, and organic solvent were blended in the formulations shown in Table 4 to form photosensitive coloring compositions, respectively.

These were evaluated by the method shown below.

[Evaluation of Photosensitivity]

Each of the photosensitive coloring compositions of Examples 20 to 29 and Comparative Examples 6 and 7 shown in Table 4 was spin-coated on a glass substrate (size: 100×100 mm) and dried at room temperature for 30 minutes and then vacuum-dried for 20 minutes. After measuring the film thickness of the formed resist by using a film thickness meter (SURFCOM 130A, trade name; manufactured by Tokyo Seimitsu Co., Ltd.), the resist was photocured in an exposing apparatus having incorporated an ultrahigh pressure mercury lamp (trade name: Multilight ML-251A/B, manufactured by Ushio Inc.), at varied exposure amounts. The exposure amount was measured by an ultraviolet integrating photometer (tradename: UIT-150 (light receivingpart: UVD-S365), -manufactured by Ushio Inc.). Further, the resist was subjected to alkali development with 0.1% aqueous solution (25° C.) of Developer 9033 (manufactured by Shipley Far East Ltd.), which was an alkali developer containing potassium carbonate (the developing time being set to twice the time required for complete development of the resist film before exposure to light by the alkali development). After completion of the alkali development, the glass substrate was washed with water, dried by air spraying and the film thickness of the remaining resist was measured. The photosensitivity of the photosensitive coloring composition for color filters was defined as the exposure amount at which the value calculated by the following equation reached 95% or more (remaining film sensitivity). Table 4 shows the results obtained.

$$Remaining Film Sensitivity ( \% ) = 100 \times \frac{( Film thickness after alkali development )}{( Film thickness before alkali development )}$$

The results shown in Table 4 indicate that the use of the modified carbon black treated with the compound having an ethylenically unsaturated group and an isocyanate group in the molecule gave rise to considerably high photosensitivity.

[Evaluation of Physical Properties of Coating Film]

Each of the photosensitive coloring compositions (black matrix resist compositions) of Examples 20 to 29 and Comparative Examples 6 and 7 shown in Table 4 was spin-coated on a glass substrate (size: 100×100 mm) and dried at room temperature for 30 minutes and then vacuum-dried for 20 minutes. After photocuring by using an ultrahigh pressure mercury lamp at the exposure amount twice that of the photosensitivity of each photosensitive composition, the resulting composition was post-baked at 200° C. for 30 minutes for performing the following evaluations.

(1) OD Values

By measuring transmittance at 550 nm by using a standard plate having a known optical density (OD) value, a calibration curve was prepared. Then, each of the substrates coated with the photosensitive coloring compositions of Examples and Comparative Examples was measured of transmittance at 550 nm to obtain OD values. Table 4 shows the results obtained.

(2) Reflectivity

By using a spectrophotometer (UV-3100PC, manufactured by Shimadzu Corporation), the reflectivity at 550 nm of each of the photosensitive coloring compositions was measured.

(3) Pencil Scratch Value

By the method prescribed by JIS K5400 “General Test Methods for Coating Composition, 8.4: Pencil Scratch Value”, the strength of coating film of each sample was evaluated. Table 4 shows the results obtained.

TABLE 4

| | | |
|---|---|---|
| Example 20 | Example 21 | Example 22 |

Formulation (part by mass)

| | | | | | | | | | |
|---|---|---|---|---|---|---|---|---|---|
| Coloring composition | Coloring | 1059.3 | | Coloring | 1059.3 | | Coloring | 1380.3 | |
| | composition-10 | | | composition-10 | | | composition-11 | | |
| Binder resin (A) | AP-3 | 429 | (100) | AP-3 | 429 | (100) | AP-3 | 428 | (100) |
| Colorant (B) | SB4 | 162 | (162) | SB4 | 162 | (162) | SB4 | 242 | (242) |
| Compound having a double | MOI | 8 | (8) | MOI | 8 | (8) | MOI | 10 | (10) |
| bond with an isocyanate | | | | | | | | | |
| Organic solvent (C) | PMA | 400 | (0) | PMA | 400 | (0) | PMA | 600 | (0) |
| Dispersant | DOPA-33 | 60 | (18) | DOPA-33 | 60 | (18) | DOPA-33 | 100 | (30) |
| Dibutyltin dilaurate | | 0.3 | (0.3) | | 0.3 | (0.3) | | 0.3 | (0.3) |
| (E) Ethylenically unsaturated | DPHA | 65.0 | | DPHA | 65.0 | | DPHA | 85.0 | |
| monomer | | | | | | | | | |
| (D) Photopolymerization | EMK | 3.0 | | EMK | 3.0 | | EMK | 4.0 | |
| initiator | HABI | 24 | | HABI | 24.0 | | HABI | 30.0 | |
| | MN3M | 2.4 | | | | | | | |
| (F) Poly thiol | TPMP | 40.0 | | BDTP | 50.0 | | TPMP | 50.0 | |
| (C) Organic solvent | CH | 900 | | CH | 900 | | CH | 900 | |

Results of Evaluation

| | | | |
|---|---|---|---|
| Photosensitivity (mj/cm²) | 20 | 20 | 30 |
| Film thickness after | 1.35 | 1.24 | 1.01 |
| post-baking (μm) | | | |
| OD value (550 nm) | 3.5 | 3.3 | 3.1 |
| Reflectivity (550 nm %) | 1.2 | 0.9 | 1.0 |
| Pencil scratch value | 3 H | 3 H | 3 H |

| | | |
|---|---|---|
| Example 23 | Example 24 | Example 25 |

Formulation (part by mass)

| | | | | | | | | | |
|---|---|---|---|---|---|---|---|---|---|
| Coloring composition | Coloring | 1380.3 | | Coloring | 1056.3 | | Coloring | 1056.3 | |
| | composition-11 | | | composition-12 | | | composition-12 | | |
| Binder resin (A) | AP-3 | 428 | (100) | AP-3 | 429 | (100) | AP-3 | 429 | (100) |
| Colorant (B) | SB4 | 242 | (242) | SB4 | 162 | (162) | SB4 | 162 | (162) |
| Compound having a double | MOI | 10 | (10) | MOI | 5 | (5) | MOI | 5 | (5) |
| bond with an isocyanate | | | | | | | | | |
| Organic solvent (C) | PMA | 600 | (0) | PMA | 400 | (0) | PMA | 400 | (0) |
| Dispersant | DOPA-33 | 100 | (30) | DOPA-33 | 60 | (18) | DOPA-33 | 60 | (18) |
| Dibutyltin dilaurate | | 0.3 | (0.3) | | 0.3 | (0.3) | | 0.3 | (0.3) |
| (E) Ethylenically unsaturated | DPHA | 85.0 | | DPHA | 60.0 | | DPHA | 60.0 | |
| monomer | | | | | | | | | |
| (D) Photopolymerization | EMK | 3.0 | | EMK | 3.0 | | Irgacure 369 | 30.0 | |
| initiator | HABI | 24.0 | | Irgacure 907 | 24.0 | | | | |
| | N3B | 3.0 | | | | | | | |
| (F) Poly thiol | TPMP | 40.0 | | TPMP | 50.0 | | TPMP | 50.0 | |
| (C) Organic solvent | CH | 1200 | | CH | 900 | | CH | 900 | |

Results of Evaluation

| | | | |
|---|---|---|---|
| Photosensitivity (mj/cm²) | 40 | 40 | 40 |
| Film thickness after | 0.99 | 1.25 | 1.22 |
| post-baking (μm) | | | |
| OD value (550 nm) | 3.1 | 3.2 | 3.2 |
| Reflectivity (550 nm %) | 1.0 | 0.9 | 0.9 |
| Pencil scratch | 3 H | 3 H | 3 H |

| | | |
|---|---|---|
| Example 26 | Example 27 | Example 28 |

Formulation (part by mass)

| | | | | | | | | | |
|---|---|---|---|---|---|---|---|---|---|
| Coloring composition | Coloring | 1059.3 | | Coloring | 1059.3 | | Coloring | 1064.3 | |
| | composition-13 | | | composition-13 | | | composition-14 | | |
| Binder resin (A) | AP-4 | 429 | (100) | AP-4 | 429 | (100) | AP-5 | 434 | (100) |
| Colorant (B) | SB250 | 162 | (162) | SB250 | 162 | (162) | SB100 | 162 | (162) |
| Compound having a double | MOI | 8 | (8) | MOI | 8 | (8) | MOI | 8 | (8) |
| bond with an isocyanate | | | | | | | | | |
| Organic solvent (C) | PMA | 400 | (0) | PMA | 400 | (0) | PMA | 400 | (0) |
| Dispersant | DOPA-33 | 60 | (18) | DOPA-33 | 60 | (18) | DOPA-33 | 60 | (18) |
| Dibutyltin dilaurate | | 0.3 | (0.3) | | 0.3 | (0.3) | | 0.3 | (0.3) |
| (B) Ethylenically unsaturated | DPHA | 85.0 | | DPHA | 60.0 | | DPHA | 60.0 | |
| monomer | | | | | | | | | |
| (D) Photopolymerization | EMK | 3.0 | | EMK | 3.0 | | | | |
| initiator | EAQ | 3.0 | | HABI | 24.0 | | Triazine A | 30.0 | |
| | N3M | 20.0 | | | | | | | |
| (F) Poly thiol | TPMP | 40.0 | | BDTP | 50.0 | | TPMP | 50.0 | |
| (C) Organic solvent | CH | 900 | | CH | 900 | | CH | 900 | |

Results of Evaluation

| | | | |
|---|---|---|---|
| Photosensitivity (mj/cm²) | 50 | 20 | 50 |
| Film thickness after | 1.32 | 1.20 | 1.27 |
| post-baking (μm) | | | |
| OD value (550 nm) | 3.4 | 3.2 | 3.3 |
| Reflectivity (550 nm %) | 1.2 | 0.9 | 0.8 |
| Pencil scratch value | 3 H | 3 H | 3 H |

| | | |
|---|---|---|
| Example 29 | Comparative Example 6 | Comparative Example 7 |

Formulation (part by mass)

| | | | | | | | | | |
|---|---|---|---|---|---|---|---|---|---|
| Coloring composition | Coloring | 1064.3 | | Comparative | 1039 | | Comparative | 1039 | |
| | composition-14 | | | Coloring | | | Coloring | | |
| | | | | composition-2 | | | composition-2 | | |
| Binder resin (A) | AP-5 | 434 | (100) | AP-3 | 429 | (100) | AP-3 | 429 | (100) |
| Colorant (B) | SB100 | 162 | (162) | SB4 | 150 | (150) | SB4 | 150 | (150) |
| Compound having a double | MOI | 8 | (8) | | | | | | |
| bond with an isocyanate | | | | | | | | | |
| Organic solvent (C) | PMA | 400 | (0) | PMA | 400 | (0) | PMA | 400 | (0) |
| Dispersant | DOPA-33 | 60 | (18) | DOPA-33 | 60 | (18) | DOPA-33 | 60 | (18) |
| Dibutyltin dilaurate | | 0.3 | (0.3) | | | | | 0.3 | (0.3) |
| (E) Ethylenically unsaturated | DPHA | 75.0 | | DPHA | 65.0 | | DPHA | 60.0 | |
| monomer | | | | | | | | | |
| (D) Photopolymerization | EMK | 3.0 | | EMK | 3.0 | | EMK | 3.0 | |
| initiator | Cation Dyestuff | 3.0 | | HABI | 24.0 | | HABI | 24.0 | |
| | N3M | 20.0 | | MN3M | 2.4 | | | | |
| (F) Poly thiol | TPMP | 40.0 | | TPMP | 40.0 | | BDTP | 50.0 | |
| (C) Organic solvent | CH | 1200 | | CH | 900 | | CH | 900 | |

Results of Evaluation

| | | | |
|---|---|---|---|
| Photosensitivity (mj/cm²) | 40 | 200 | 150 |
| Film thickness after | 1.25 | 1.30 | 1.27 |
| post-baking (μm) | | | |
| OD value (550 nm) | 3.2 | 3.3 | 3.2 |
| Reflectivity (550 nm %) | 1.1 | 2.1 | 2.0 |
| Pencil scratch value | 3 H | 3 H | 3 H |

Parenthetical values in the column of coloring composition indicate solids content in part by mass.
SB-4: Special Black 4, carbon black manufactured by Degussa AG (average particle diameter: 25 nm)
MOI: 2-Methacryloyloxyethyl isocyanate
PMA: Propylene glycol mono methyl ether acetate
DOPA-33: FLOWLEN DOPA-33 (Solids content 30%), dispersant manufactured by Kyoeisha Chemical Co., Ltd.
DPHA: Dipentaerythritol hexaacrylate
EMK: 4,4′-Bis(N,N-diethylamino)benzophenone
HABI: 2,2′-Bis(o-chlorophenyl)-4,4′,5,5′-tetraphenyl-1,2′-biimidazole
MN3M: Tetra-n-butylammonium methyltris[1-(4-methylnaphthyl)]borate
TPMP: Trimethylolpropane tristhiopropionate
CH: Cyclohexanone
BDTP: 1,4-Butane-diol bisthiopropionate
N3B: Tetra-n-butylammonium n-butyltri(1-naphthyl)borate
Irgacure 907: 2-Methyl-1-[4-methylthio)phenyl]-morpholinopropan-1-one (Ciba Specialty Chemicals K. K.)
Irgacure 369: 2-Benzyl-2-dimethylamino-1-(4-morpholinophenyl)butanone-1 (Ciba Specialty Chemicals K. K.)
SB250: Special Black 250, carbon black manufactured by Degussa AG (average particle diameter: 56 nm)
EAQ: 2-Ethylanthraquinone
N3M: Tetra-n-butylammonium methylnaphthylborate
SB100: Special Black 100, carbon black manufactured by Degussa AG (average particle diameter: 50 nm)
Triazine A: 2-(4-Methoxyphenyl)-4,6-bis(trichloromethyl)-s-triazine
Cation Dyestuff: Cation part; Table 1 No. 3, anion part; tetrafluoroborate

The results shown in Table 4 verified that photosensitive coloring compositions using the modified carbon black treated with the compound havingi an ethylenically unsaturated group and an isocyanate group in one molecule is characterized by having high photosensitivity even at high optical densities and providing coating film having low reflectivity.

### SYNTHESIS EXAMPLE 14

### Synthesis of Epoxy(meth)acrylate Resin (EP-3)

208 mass parts of cresol novolak epoxy resin (EPICLON N-665, manufactured by Dainippon Ink and Chemicals Ltd., epoxy equivalent: 208, phenyl nucleus number: 6 to 7), 72 mass parts of acrylic acid, 0.28 mass parts of hydroquinone, and 120.9 mass parts of diethylene glycol ethyl ether acetate were charged and the mixture was heated to 95° C. After confirming the uniform dissolution of the mixture, 1.4 mass parts of triphenylphosphine was charged and the resulting mixture was heated to 100° C. and allowed to react for about 30 hours to obtain a reaction mixture having an acid value of 0.5 mgKOH/g. To this was charged 16 mass parts of succinic anhydride and the mixture was heated to 90° C. and allowed to react for about 6 hours. The disappearance of absorption of the acid anhydride was confirmed by IR analysis to obtain novolak epoxyacrylate resin EP-3 having a solids acid value of 32 mgKOH/g and a solids content of 71%.

### SYNTHESIS EXAMPLE 15

### Synthesis of Epoxy(meth)acrylate Resin (EP-4)

211 mass parts of cresol novolak epoxy resin (EPICLONN-660, manufactured by Dainippon Ink and Chemicals Ltd., epoxy equivalent: 211, phenyl nucleus number: 4.3), 72 mass parts of acrylic acid, 0.28 mass parts of hydroquinone, and 122.1 mass parts of diethylene glycol ethyl ether acetate were charged and the mixture was heated to 95° C. After confirming the uniform dissolution of the mixture, 1.4 mass parts of triphenylphosphine was charged and the resulting mixture was heated to 100° C. and allowed to react for about 30 hours to obtain a reaction mixture having an acid value of 0.5 mgKOH/g. To this was charged 16 mass parts of succinic anhydride and the mixture was heated to 90° C. and allowed to react for about 6 hours. The disappearance of absorption of the acid anhydride was confirmed by IR analysis to obtain novolak epoxyacrylate resin EP-4 having a solids acid value of 30 mgKOH/g and a solids content of 71%.

### SYNTHESIS EXAMPLE 16

### Synthesis of Epoxy(meth)acrylate resin (EP-5)

200 mass parts of cresol novolak epoxy resin (EPICLON N-655-EXP-S, manufactured by Dainippon Ink and Chemicals Ltd., epoxy equivalent: 200, phenyl nucleus number: 4.1), 72 mass parts of acrylic acid, 0.27 mass parts of hydroquinone, and 117.6 mass parts of diethylene glycol ethyl ether acetate were charged and the mixture was heated to 95° C. After confirming the uniform dissolution of the mixture, 1.4 mass parts of triphenylphosphine was charged and the resulting mixture was heated to 100° C. and allowed to react for about 30 hours to obtain a reaction mixture having an acid value of 0.5 mgKOH/g. To this was charged 16 mass parts of succinic anhydride and the mixture was heated to 900° C. and allowed to react for about 6 hours. The disappearance of absorption of the acid anhydride was confirmed by IR analysis to obtain novolak epoxyacrylate resin EP-5 having a solids acid value of 30 mgKOH/g and a solids content of 71%.

### SYNTHESIS EXAMPLE 17

### Synthesis of Epoxy(methacrylate Resin (EP-6)

210 mass parts of cresol novolak epoxy resin (EPOTOHTO YDCN-704, manufactured by Tohto Kasei Co., Ltd., epoxy equivalent: 210, phenyl nucleus number: 9 to 10), 72 mass parts of acrylic acid, 0.28 mass parts of hydroquinone, and 232.6 mass parts of diethylene glycol ethyl ether acetate were charged and the mixture was heated to 95° C. After confirming the uniform dissolution of the mixture, 1.4 mass parts of triphenylphosphine was charged and the resulting mixture was heated to 100° C. and allowed to react for about 30 hours to obtain a reaction mixture having an acid value of 0.5 mgKOH/g. To this was charged 16 mass parts of succinic anhydride and the mixture was heated to 90° C. and allowed to react for about 6 hours. The disappearance of absorption of the acid anhydride was confirmed by IR analysis to obtain novolak epoxyacrylate resin EP-6 having a solids acid value of 30 mgKOH/g and a solids content of 56%.

### SYNTHESIS EXAMPLE 18

### Synthesis of Acrylic Copolymer (AP-6)

In a four-necked flask equipped with a dropping funnel, a thermometer, a condenser and a stirrer were charged 12.0 mass parts of methacrylic acid (MA), 13.0 mass parts of methyl methacrylate (NMA), 39.0 mass parts of n-butyl methacrylate (BMA), 11.0 mass parts of N-acryloylmorpholine (ACMO), and 225.0 mass parts of PMA and the inside of the flask was purged with nitrogen for 1 hour. Further, after elevating the temperature up to 90° C. on an oil bath, a mixed solution of 12.0 mass parts of MA, 13.0 mass parts ofMMA, 39.0 mass parts of BMA, 11.0 mass parts ofACMO, 225.0 mass parts of PMA and 3.2 mass parts of 2,2′-azobisisobutyronitrile (AIBN) was dripped over 1 hour. After 3 hours' polymerization, the temperature was elevated up to 100° C. and a mixed solution of 1.0 mass part of AIBN and 15.0 mass parts of PMA was added and the polymerization was performed for 1.5 hours and then the reaction mixture was left to cool. The acrylic copolymer having a carboxyl group thus obtained was named-AP-6. AP-6 had a solids content of 23.3% and acid value of 94 mgKOH/g and a weight average molecular weight of 26,000 in terms of polystyrene as measured by GPC.

### SYNTHESIS EXAMPLE 19

### Synthesis of Acrylic Copolymer (AP-7)

In a four-necked flask equipped with a dropping funnel, a thermometer, a condenser and a stirrer were charged 12.0 mass parts of MA, 12.0 mass parts of MMA, 41.0 mass parts of BMA, 10.0 mass parts of N-vinylcaprolactam (VC), and 225.0 mass parts of PMA and the inside of the flask was purged with nitrogen for 1 hour. Further, after elevating the temperature up to 90° C. on an oil bath, a mixed solution of 12.0 mass parts of MA, 12.0 mass parts of MMA, 41.0 mass parts of BMA, 10.0 mass parts of VC, 225.0 mass parts of PMA and 3.2 mass parts of AIBN was dripped over 1 hour. After 3 hours' polymerization, a mixed solution of 1.0 mass part of AIBN and 15.0 mass parts of PMA was added and the temperature was elevated up to 100° C. and the polymerization was performed for 1.5 hours and then the reaction mixture was left to cool. The acrylic copolymer having a carboxyl group thus obtained was named AP-7. AP-7 had a solids content of 22.5% and acid value of 92 mgKOH/g and a weight average molecular weight of 22,000 in terms of polystyrene as measured by GPC.

### EXAMPLES 30 TO 35 AND COMPARATIVE EXAMPLES 8 and 9

### Evaluation of Compatibility between Epoxyacrylate Resins and Acrylic Copolymers

The above-mentioned novolak epoxyacrylate resins and the acrylic copolymers were mixed with each other so that their solids contents was each 1.0 mass part and the solids contents of the mixture was adjusted to 20% with cyclohexanone. Thereafter, the mixture was coated to a dry thickness of about 20 μm on a polyethylene terephthalate film having a thickness of 50 μm by using an applicator. After evaporating the solvent at room temperature for 24 hours or more to dry the film the absorbance at 400 nm of each coated film was measured by using a spectrophotometer (UV-3100PC, manufactured by Shimadzu Corporation) and the absorbance at 400 nm of each coating film per 10 μm thickness was calculated. Table 5 shows the results obtained. Here, thepoorerthecompatibilitybetweenthenovolak epoxyacrylate resin and the acrylic copolymer having a carboxyl group is, the more turbid the coating composition becomes because of occurrence of phase separation of the resin, resulting in increased absorbance. On the contrary, if the compatibility is good, no phase separation will occur so that the absorbance becomes smaller.

The results shown in Table 5 demonstrated that in the case where the novolak epoxyacrylate resin having a phenyl nucleus number of 7 or less was used, the absorbance at 400 nm was small, which indicated its good compatibility with the acrylic copolymer having a carboxyl group.

TABLE 5

| | | | Absorbance at 400 nm |
|---|---|---|---|
| | Component | Component | per 10 μm of film |
| | (A) | (A′) | thickness |
| Example 30 | AP-6 | EP-3 | 0.043 |
| Example 31 | AP-7 | EP-3 | 0.045 |
| Example 32 | AP-6 | EP-4 | 0.038 |
| Example 33 | AP-7 | EP-4 | 0.047 |
| Example 34 | AP-6 | EP-5 | 0.025 |
| Example 35 | AP-7 | EP-5 | 0.030 |
| Comparative | AP-6 | EP-6 | 0.145 |
| example 8 | | | |
| Comparative | AP-7 | EP-6 | 0.156 |
| example 9 | | | |

### EXAMPLE 36

### Preparation of Coloring Composition

A mixture of 5.6 mass parts of EP-3 (solids content 4.0 mass parts), 25.8 mass parts of AP-6 (solids content 6.0 mass parts), 3.7 mass parts of FLOWLEN DOPA-33 (manufactured by Kyoeisha Chemical Co., Ltd., dispersant, solids content 30%) and 9.4 mass parts of Special Black 4 (carbon black available from Degussa AG) was left to stand overnight. After stirring it for additional 1 hour, the mixture was passed 4 times through a three-roll mill (Model-RIII-IRM-2, manufacturedbyKodairaSeisakusho Co., Ltd.). To the coloring composition thus obtained was added cyclohexanone to adjust the concentration to obtain a coloring composition having a solids content of 18.0%.

### EXAMPLES 37 TO 44 AND COMPARATIVE EXAMPLES 10 TO 12

### Preparation of Coloring Compositions

Preparation of coloring compositions was performed in the same manner as in Example 36 by using the formulations shown in Table 6.

TABLE 6

| | | | |
|---|---|---|---|
| | | Compounding | Compounding |
| | | Amount | Amount of Solids |
| Component | Kind | (part by mass) | (part by mass) |

Example 36

| | | | |
|---|---|---|---|
| (A) | AP-6 | 25.8 | 6.0 |
| (A′) | EP-3 | 5.6 | 4.0 |
| Dispersant | DOPA-33 | 3.7 | 1.1 |
| (B) | SB-4 | 9.4 | 9.4 |
| (C) | — | — | — |

Example 37

| | | | |
|---|---|---|---|
| (A) | AP-6 | 21.7 | 5.0 |
| (A′) | EP-4 | 7.0 | 5.0 |
| Dispersant | DOPA-33 | 3.7 | 1.1 |
| (B) | SB-4 | 9.4 | 9.4 |
| (C) | — | — | — |

Example 38

| | | | |
|---|---|---|---|
| (A) | AP-6 | 17.8 | 4.0 |
| (A′) | EP-5 | 8.5 | 6.0 |
| Dispersant | DOPA-33 | 3.7 | 1.1 |
| (B) | SB-4 | 9.4 | 9.4 |
| (C) | PMA | 5.0 | — |

Example 39

| | | | |
|---|---|---|---|
| (A) | AP-7 | 17.8 | 4.0 |
| (A′) | EP-3 | 8.5 | 6.0 |
| Dispersant | DOPA-33 | 3.7 | 1.1 |
| (B) | SB-4 | 9.4 | 9.4 |
| (C) | PMA | 5.0 | — |

Example 40

| | | | |
|---|---|---|---|
| (A) | AP-7 | 17.8 | 4.0 |
| (A′) | EP-4 | 8.5 | 6.0 |
| Dispersant | DOPA-33 | 3.7 | 1.1 |
| (B) | SB-4 | 9.4 | 9.4 |
| (C) | PMA | 5.0 | — |

Example 41

| | | | |
|---|---|---|---|
| (A) | AP-7 | 17.8 | 4.0 |
| (A′) | EP-5 | 8.5 | 6.0 |
| Dispersant | DOPA-33 | 3.7 | 1.1 |
| (B) | SB-4 | 9.4 | 9.4 |
| (C) | PMA | 5.0 | — |

Example 42

| | | | |
|---|---|---|---|
| (A) | AP-6 | 17.2 | 4.0 |
| (A′) | EP-5 | 8.5 | 6.0 |
| Dispersant | DOPA-33 | 4.6 | 1.4 |
| (B) | SB-4 | 14.0 | 14.0 |
| (C) | PMA | 13.0 | — |

Example 43

| | | | |
|---|---|---|---|
| (A) | AP-7 | 17.8 | 4.0 |
| (A′) | EP-5 | 8.5 | 6.0 |
| Dispersant | DOPA-33 | 4.6 | 1.4 |
| (B) | SB-4 | 14.0 | 14.0 |
| (C) | PMA | 13.0 | — |

Example 44

| | | | |
|---|---|---|---|
| (A) | AP-6 | 17.2 | 4.0 |
| (A′) | EP-5 | 8.5 | 6.0 |
| Dispersant | DOPA-33 | 4.6 | 1.4 |
| (B) | SB-250 | 14.0 | 14.0 |
| (C) | PMA | 13.0 | — |

Comparative Example 10

| | | | |
|---|---|---|---|
| (A) | AP-6 | 17.2 | 4.0 |
| (A′) | EP-6 | 10.7 | 6.0 |
| Dispersant | DOPA-33 | 3.7 | 1.1 |
| (B) | SB-4 | 9.4 | 9.4 |
| (C) | PMA | 5.0 | — |

Comparative Example 11

| | | | |
|---|---|---|---|
| (A) | AP-7 | 17.8 | 4.0 |
| (A′) | EP-6 | 10.7 | 6.0 |
| Dispersant | DOPA-33 | 3.7 | 1.1 |
| (B) | SB-250 | 9.4 | 9.4 |
| (C) | PMA | 5.0 | — |

Comparative Example 12

| | | | |
|---|---|---|---|
| (A) | AP-6 | 42.9 | 10.0 |
| (A′) | — | — | — |
| Dispersant | DOPA-33 | 3.7 | 1.1 |
| (B) | SB-4 | 9.4 | 9.4 |
| (C) | — | — | — |

(A): Binder resin having an amide group and a carboxyl group
(A′): Epoxy (meth)acrylate resin
(B): Colorant
(C): Organic solvent
DOPA-33: FLOWLEN DOPA-33 (Solids content 30%), dispersant manufactured by Kyoeisha Chemical Co., Ltd.
SB-4: Special Black 4, carbon black manufactured by Degussa AG (average particle diameter: 25 nm)
PMA: Propylene glycol mono methyl ether acetate
SB250: Special Black 250, carbon black manufactured by Degussa AG (average particle diameter: 56 nm)

### EXAMPLES 45 TO 53 AND COMPARATIVE EXAMPLES 13 TO 15

### Preparation of Photosensitive Coloring Compositions for Color Filters (Black Matrix Resists)

Photosensitive coloring compositions for color filters having formulations of Examples 45 to 53 and Comparative Examples 13 to 15 shown in Table 7 were prepared and filtered through a filter having apore size of 0.8 μm (for GFP, Kiriyama Filter Paper), followed by evaluation of various properties.

[Evaluation of Photosensitivity]

Each of the photosensitive coloring compositions of Examples 45 to 53 and Comparative Examples 13 to 15 shown in Table 7 was spin-coated on a glass substrate (size: 100×100 mm) and dried at room temperature for 30 minutes and then vacuum-dried for 30 minutes at room temperature. After measuring the film thickness of the formed resist by using a film thickness meter (SURFCOM 130A, trade name; manufactured by Tokyo Seimitsu Co., Ltd.), the resist was photocured in an exposing apparatus having incorporated therein an ultrahigh pressure mercury lamp (trade name: Multilight ML-251A/B, manufactured by Ushio Inc.) at varied exposure amounts. The exposure amount was measured by an ultraviolet integrating photometer (trade name: UIT-150, light receiving part: UVD-S365, manufactured by Ushio Inc.). Further, the resist was subjected to alkali development with 0.1% aqueous solution (25° C.) of Developer 9033 (manufactured by Shipley Far East Ltd.), which was an alkali developer containing potassium carbonate, for a predetermined amount of time (the developing time being set to twice the time required for complete development of the resist film before exposure to light by the alkali development). After completion of the alkali development, the glass substrate was washed with water, dried by air spraying and the film thickness of the remaining resist was measured. The photosensitivity of the photosensitive coloring composition for color filters was defined as the exposure amount at which the value calculatedbythe following equation (remaining filmsensitivity) became 95% or greater. Table 7 shows the results obtained.

$$Remaining Film Sensitivity ( \% ) = 100 \times \frac{( Film thickness after alkali development )}{( Film thickness before alkali development )}$$

[Evaluation of Physical Properties of Resist]

Each of the photosensitive coloring compositions of Examples 45 to 53 and Comparative Examples 13 to 15 shown in Table 7 was spin-coated on a glass substrate (size: 100×100 mm) and dried at room temperature for 30 minutes and then vacuum-dried at room temperature for 30 minutes. After photocuring by using an ultra-high pressure mercury lamp at the exposure amount twice that of the photosensitivity of each composition (resist), the resist was post-baked at 200° C. for 30 minutes and the resist-coated glass substrate thus obtained was used for performing the following evaluations.

(1) OD Values

By measuring transmittance at 550 nm by using a standard plate having a known optical density (OD) value, a calibration curve was prepared. Then, each of the resist-coated substrates of Examples and Comparative Examples was measured of transmittance at 550 nm to obtain OD values. Table 7 shows the results obtained.

(2) Reflectivity

By using a spectrophotometer (UV-3100PC, manufactured by Shimadzu Corporation), the reflectivity at 550 nm of each of the resists was measured.

(3) Pencil Scratch Value

By the method prescribed by JIS K5400 “General Test Methods for Coating Composition, 8.4: Pencil Scratch Value”, the strength of coating film of each sample was evaluated. Table 7 shows the results obtained.

TABLE 7

| | | |
|---|---|---|
| Example 45 | Example 46 | Example 47 |

Formulation (part by mass)

| Kinds of Coloring composition | Example 36 | | Example 37 | | Example 38 | |
|---|---|---|---|---|---|---|
| Component (A) | AP-6 | 60 | AP-6 | 50 | AP-6 | 40 |
| Component (A′) | EP-3 | 40 | EP-4 | 50 | EP-5 | 60 |
| Component (B) | SB-4 | 94 | SB-4 | 94 | SB-4 | 94 |
| Dispersant | DOPA-33 | 11 | DOPA-33 | 11 | DOPA-33 | 11 |
| Component (C) | CH + PMA | 934 | CH + PMA | 934 | CH + PMA | 934 |
| (D) Photopolymerization initiator | EMK | 2.5 | EMK | 2.5 | EMK | 2.5 |
| | HABI | 17.0 | HABI | 17.0 | HABI | 17.0 |
| | MN3M | 2.0 | | | | |
| (F) Poly thiol | TPMP | 30.0 | TPMP | 25.0 | BDTP | 30.0 |
| (C) Organic solvent | CH | 175 | CH | 175 | CH | 175 |

Results of Evaluation

| | | | |
|---|---|---|---|
| Photosensitivity (mj/cm²) | 30 | 20 | 40 |
| Film thickness after post-baking (μm) | 1.23 | 1.27 | 1.13 |
| OD value (550 nm) | 3.4 | 3.5 | 3.1 |
| Reflectivity (550 nm %) | 1.3 | 1.0 | 0.9 |
| Pencil scratch value | 5 H | 6 H | 6 H |

| | | |
|---|---|---|
| Example 48 | Example 49 | Example 50 |

Formulation (part by mass)

| Kinds of Coloring composition | Example 39 | | Example 40 | | Example 41 | |
|---|---|---|---|---|---|---|
| Component (A) | AP-7 | 40 | AP-7 | 40 | AP-7 | 40 |
| Component (A′) | EP-3 | 60 | EP-4 | 60 | EP-5 | 60 |
| Component (B) | SB-4 | 94 | SB-4 | 94 | SB-4 | 94 |
| Dispersant | DOPA-33 | 11 | DOPA-33 | 11 | DOPA-33 | 11 |
| Component (C) | CH + PMA | 934 | CH + PMA | 934 | CH + PMA | 934 |
| (D) Photopolymerization initiator | TAZ | 15.0 | EMK | 3.0 | Irgacure 369 | 30.0 |
| | | | Irgacure 907 | 25.0 | | |
| (F) Poly thiol | TPMP | 25.0 | TPMP | 40.0 | BDTP | 40.0 |
| (C) Organic solvent | CH | 175 | CH | 175 | CH | 175 |

Results of Evaluation

| | | | |
|---|---|---|---|
| Photosensitivity (mj/cm²) | 40 | 40 | 40 |
| Film thickness after post-baking (μm) | 1.01 | 1.33 | 1.22 |
| OD value (550 nm) | 3.1 | 3.5 | 3.3 |
| Reflectivity (550 nm %) | 1.0 | 1.0 | 0.9 |
| Pencil scratch value | 5 H | 5 H | 4 H |

| | | |
|---|---|---|
| Example 51 | Example 52 | Example 53 |

Formulation (part by mass)

| Kinds of Coloring composition | Example 42 | | Example 43 | | Example 44 | |
|---|---|---|---|---|---|---|
| Component (A) | AP-6 | 40 | AP-7 | 40 | AP-6 | 40 |
| Component (A′) | EP-5 | 60 | EP-5 | 60 | EP-5 | 60 |
| Component (B) | SB-4 | 140 | SB-4 | 140 | SB-250 | 140 |
| Dispersant | DOPA-33 | 14 | DOPA-33 | 14 | DOPA-33 | 14 |
| Component (C) | CH + PMA | 1150 | CH + PMA | 1150 | CH + PMA | 1150 |
| (D) Photopolymerization initiator | EMK | 3.0 | EMK | 3.0 | EMK | 2.0 |
| | HABI | 20.0 | HABI | 20.0 | EAQ | 2.0 |
| | MN3M | 3.0 | | | MN3M | 20.0 |
| (F) Poly thiol | TPMP | 50.0 | TPMP | 50.0 | TPMP | 50.0 |
| (C) Organic solvent | CH | 220 | CH | 220 | CH | 220 |

Results of Evaluation

| | | | |
|---|---|---|---|
| Photosensitivity (mj/cm²) | 40 | 30 | 50 |
| Film thickness after post-baking (μm) | 1.02 | 1.01 | 1.35 |
| OD value (550 nm) | 3.1 | 3.1 | 3.5 |
| Reflectivity (550 nm %) | 1.1 | 1.0 | 1.2 |
| Pencil scratch value | 4 H | 4 H | 4 H |

| | | |
|---|---|---|
| Comparative | Comparative | Comparative |
| Example 13 | Example 14 | Example 15 |

Formulation (part by mass)

| Kinds of Coloring composition | Comparative | | Comparative | | Comparative | |
|---|---|---|---|---|---|---|
| | Example 10 | | Example 11 | | Example 12 | |
| Component (A) | AP-6 | 40 | AP-7 | 40 | AP-6 | 40 |
| Component (A′) | EP-6 | 60 | EP-6 | 60 | | |
| Component (B) | SB-4 | 94 | SB-4 | 94 | SB-4 | 94 |
| Dispersant | DOPA-33 | 11 | DOPA-33 | 11 | DOPA-33 | 11 |
| Component (C) | CH + PMA | 934 | CH + PMA | 934 | CH + PMA | 934 |
| (D) Photopolymerization initiator | EMK | 2.5 | EMK | 2.5 | EMK | 2.5 |
| | HABI | 17.0 | HABI | 17.0 | HABI | 17.0 |
| | MN3M | 2.0 | | | | |
| (F) Poly thiol | TPMP | 30.0 | TPMP | 25.0 | TPMP | 25.0 |
| (C) Organic solvent | CH | 175 | CH | 175 | CH | 175 |

Results of Evaluation

| | | | |
|---|---|---|---|
| Photosensitivity (mj/cm²) | 20 | 20 | 200 |
| Film thickness after post-baking (μm) | 1.21 | 1.31 | 1.26 |
| OD value (550 nm) | 3.4 | 3.5 | 3.2 |
| Reflectivity (550 nm %) | 2.3 | 2.4 | 1.8 |
| Pencil scratch value | 5 H | 5 H | 3 H |

The amounts of components (A), (A′), and (B) and dispersant are expressed in part by mass of the solids.
EMK: 4,4′-Bis(N,N-diethylamino)benzophenone
HABI: 2,2′-Bis(o-chlorophenyl)-4,4′,5,5′-tetraphenyl-1,2′-biimidazole
MN3M: Tetra-n-butylammonium methyltris[1-(4-methylnaphthyl)]borate
TPMP: Trimethylolpropane tristhiopropionate
CH: Cyclohexanone
BDTP: 1,4-Butane-diol bisthiopropionate
TAZ: 2-(4-Methoxystyryl)-4,6-bis(trichloromethyl)-s-triazine
Irgacure 907: 2-Methyl-1-[4-(methylthio)phenyl]-2-morpholinopropan-1-one (Ciba Specialty Chemicals K. K.)
Irgacure 369: 2-Benzyl-2-dimethylamino-1-(4-morpholinophenyl)butanone-1 (Ciba Specialty Chemicals K. K.)
EAQ: 2-Ethylanthraquinone

The results shown in Table 7 demonstrated that the black matrix resist consisting of a combination of the novolak epoxyacrylate resin having a phenyl nucleus number of 4 to 7 and the acrylic copolymer having a carboxyl group has very high sensitivity and at the same time can form a black matrix having low reflectivity because of good compatibility between the two resins.

1. A coloring composition characterized by comprising (A) a binder resin having an amido group and a carboxyl group, and (B) a coloring material.

2. A coloring composition according to claim 1, further comprising (C) an organic solvent.

3. A coloring composition according to claim 1, wherein the binder resin (A) having an amido group and a carboxyl group is an acrylic copolymer obtained by copolymerizing (a) 2 to 40 mass % of an ethylenically unsaturated monomer containing an amido group, (b) 2 to 40 mass % of an ethylenically unsaturated monomer containing a carboxyl group, and (c) 20 to 96 mass % of an ethylenically unsaturated monomer other than the (a) and (b).

4. A coloring composition according to claim 3, wherein the ethylenically unsaturated monomer (a) containing an amido group is at least one compound selected from the group consisting of N-(meth)acryloylmorpholine, N-vinylpyrrolidone and N-vinylcaprolactam.

5. A coloring composition according to any one of claims 1 to 4, further comprising (A′) an epoxy(meth)acrylate resin.

6. A coloring composition according to claim 5, wherein the epoxy(meth)acrylate resin (A′) is novolak epoxy(meth)acrylate resin having a carboxyl group.

7. A coloring composition according to claim 6, wherein the novolak epoxy (meth) acrylate resin having a carboxyl group has the number of phenyl nuclei of 4 to 7.

8. A coloring composition according to claim 6 or 7, wherein the novolak epoxy (meth) acrylate resin having a carboxyl group has an acid value of 10 to 150 mgKOH/g.

9. A coloring composition according to any one of claims 6 to 8, wherein the novolak epoxy(meth)acrylate resin having a carboxyl group has cresol novolak epoxy(meth)acrylate resin having a carboxyl group.

10. A coloring composition according to any one of claims 5 to 9, wherein a blending ratio of the binder resin (A) having an amido group and a carboxyl group to the epoxy(meth)acrylate resin (A′) is from 30:70 to 90:10 in a mass ratio.

11. A coloring composition according to any one of claims 5 to 10, comprising: 10 to 40 mass % of the binder resin (A) having an amido group and a carboxyl group; 10 to 40 mass % of the epoxy (meth) acrylate resin (A′); and 20 to 80 mass % of the coloring material (B), provided that a sum of (A), (A′) and (B) is 100 mass %.

12. A coloring composition according to any one of claims 1 to 11, wherein the coloring material (B) is a black pigment.

13. A coloring composition according to claim 12, wherein the black pigment is a carbon black.

14. A coloring composition according to claim 13, wherein the carbon black is a modified carbon black treated with a compound having an isocyanate group and an ethylenically unsaturated bond in a molecule.

15. A coloring composition according to claim 14, wherein the modified carbon black is a modified carbon black obtained by treating 100 mass parts of carbon black with 0.5 to 50 mass parts of a compound having an isocyanate group and an ethylenically unsaturated bond in a molecule.

16. A coloring composition according to claim 14 or 15, wherein the compound having an isocyanate group and an ethylenically unsaturated bond in a molecule is 2-methacryloyloxyethyl isocyanate.

17. A coloring composition according to claim 13, wherein the carbon black is a modified carbon black having a 2-methacryloyloxyethylcarbamoyl group.

18. A method of producing a coloring composition according to any one of claims 1 to 17.

19. A photosensitive coloring composition for color filters, characterized by comprising a coloring composition according to any one of claims 1 to 17.

20. A photosensitive coloring composition for color filters according to claim 19, further comprising (D) a photopolymerization initiator.

21. A photosensitive coloring composition for color filters according to claim 20, wherein the photopolymerization initiator (D) comprises at least one member selected from the group consisting of:
(i) a hexaarylbiimidazole compound;
(ii) a triazine compound;
(iii) an aminoacetophenone compound; and
(iv) a combination of a sensitizer and an organoboron salt compound of a general formula (1) 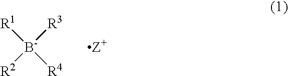
(wherein R¹, R², R³ and R⁴ represent alkyl, aryl, aralkyl, alkenyl, alkynyl, silyl or heterocyclic group, each of which may independently have a substituent group or a halogen atom, Z+represents any cation).

22. A photosensitive coloring composition for color filters according to claim 20 or 21, wherein each composition comprises the following contents of:
(A) 8 to 30 mass % of a binder resin having an amido group and a carboxyl group;
(A′) 8 to 30 mass % of an epoxy(meth)acrylate resin;
(B) 25 to 60 mass % of a coloring material; and
(D) 2 to 25 mass % of a photopolymerization initiator,
provided that a sum of the components (A), (A′), (B) and (D) is 100 mass %.

23. A photosensitive coloring composition for color filters according to claim 20, further comprising (E) an ethylenically unsaturated monomer.

24. A photosensitive coloring composition for color filters according to claim 23, wherein each composition comprises the following contents of:
(A) 10 to 40 mass % of a binder resin having an amido group and a carboxyl group alone or 10 to 40 mass % of a combination of (A) a binder resin having an amido group and a carboxyl group and
(A′) an epoxy(meth)acrylate resin;
(B) 25 to 60 mass % of a coloring material;
(D) 2 to 25 mass % of a photopolymerization initiator; and
(E) 5 to 20 mass % of an ethylenically unsaturated monomer,
provided that a sum of the components (A), (A′), (B), (D) and (E) is 100 mass %.

25. A photosensitive coloring composition for color filters according to claim 20 or 23, further comprising (F) a poly thiol as a chain transfer agent.

26. A photosensitive coloring composition for color filters according to claim 25, wherein a ration of the poly thiol (F) to the photopolymerization initiator (D) is 10:1 to 1:10.

27. A photosensitive coloring composition for color filters according to claim 25 or 26, wherein each composition comprises the following contents of:
(A) 10 to 40 mass % of a binder resin having an amido group and a carboxyl group alone or 10 to 40 mass % of a combination of (A) a binder resin having an amido group and a carboxyl group and (A′) an epoxy(meth)acrylate resin;
(B) 25 to 60 mass % of a coloring material;
(D) 2 to 20 mass % of a photopolymerization initiator;
(E) 5 to 20 mass % of an ethylenically unsaturated monomer;
and
(F) 2 to 20 mass % of a poly thiol, provided that a sum of the components (A), (A′), (B), (D), (E) and (F) is 100 mass %.

28. A photosensitive coloring composition for color filters according to claim 25 or 26, wherein each composition comprises the following contents of:
(A) 8 to 30 mass % of a binder resin having an amido group and a carboxyl group;
(A′) 8 to 30 masse of an epoxy(meth)acrylate resin;
(B) 25 to 60 mass % of a coloring material;
(D) 2 to 20 mass % of a photopolymerization initiator; and
(F) 2 to 20 mass % of a poly thiol;
provided that a sum of the components (A), (A′), (B), (D), and (F) is 100 mass %.

29. A photosensitive coloring composition for color filters according to any one of claims 19 to 28, characterized in that the composition requires a light exposure amount of 200 mJ/cm² or less for curing.

30. A method of producing a photosensitive coloring composition for color filters according to any one of claims 19 to 29.

31. A color filter characterized by using a photosensitive coloring composition for color filters according to any one of claims 19 to 29.

32. A color filter characterized by forming a black matrix using a photosensitive coloring composition for color filters containing a black pigment according to any one of claims 19 to 29.

33. A color filter according to claim 32, wherein the black pigment is a carbon black.

34. A color filter according to claim 33, wherein the carbon black is a modified carbon black treated with a compound having an isocyanate group and an ethylenically unsaturated bond in a molecule.

35. A method of producing a color filter, characterized by using a photosensitive coloring composition for color filters according to any one of claims 19 to 29.

36. A method of forming a black matrix for color filters, characterized by using a photosensitive coloring composition for color filters containing a black pigment according to any one of claims 19 to 29.

37. A method of forming a black matrix for color filters according to claim 36, wherein the black pigment is a carbon black.

38. A method of forming a black matrix for color filters according to claim 37, wherein the carbon black is a modified carbon black treated with a compound having an isocyanate group and an ethylenically unsaturated group in a molecule.

39. A black matrix resist composition for color filters, characterized by comprising a photosensitive coloring composition containing a black pigment according to any one of claims 19 to 29.

40. A black matrix formed by using a black matrix resist composition for color filters according to claim 39.
